(19) United States
(12) Patent Application Publication
(10) Pub. No.: US 2024/0328979 A1
(43) Pub. Date: Oct. 3, 2024

(54) GAS SENSOR AND METHOD OF DETECTING GAS

(71) Applicant: TDK CORPORATION, Tokyo (JP)

(72) Inventors: Takumi MATSUO, Tokyo (JP); Makoto Shibata, Tokyo (JP); Shizuko Ono, Tokyo (JP)

(73) Assignee: TDK CORPORATION, Tokyo (JP)

(21) Appl. No.: 18/602,374

(22) Filed: Mar. 12, 2024

(30) Foreign Application Priority Data
Mar. 27, 2023 (JP) 2023-050348
Dec. 14, 2023 (JP) 2023-211066

(51) Int. Cl. G01N 27/12

(52) U.S. Cl. CPC G01N 27/12

(57) ABSTRACT

A gas sensor includes a base member, a first insulating film, a second insulating film, a heater section, a first compensation element, a second compensation element, and a detection element. The base member is provided with a cavity. The first insulating film is formed above the cavity and on a cavity peripheral portion. The second insulating film is formed so as to overlap with the first insulating film. The heater section is formed between the first insulating film and the second insulating film. The first compensation element includes a first dummy material portion and a first compensation detection portion. The second compensation element includes a second dummy material portion and a second compensation detection portion. The detection element includes a detection material portion and a reaction detection portion.

### CROSS-REFERENCE TO RELATED APPLICATIONS

The present application claims priority from Japanese Patent Application No. 2023-050348 filed on Mar. 27, 2023, and Japanese Patent Application No. 2023-211066 filed on Dec. 14, 2023, the entire contents of which are hereby incorporated by reference.

### BACKGROUND

The present disclosure relates to a gas sensor and a method of detecting gas.

A gas sensor is a device that detects gases existing in an atmosphere and converts information on their type, concentration, etc., into electrical signals for output. Such a gas sensor is installed in home appliances, industrial equipment, environmental monitoring equipment, etc. and is used to detect specific gases that affect humans, the environment, etc.

Various detection methods are known for gas sensors, depending on the type of gas to be detected, concentration range, accuracy, operating principle, constituent material, etc. Among them, a gas sensor combining a detection section and a heater for controlling the temperature around the detection section is being developed as a sensor capable of reducing errors caused by temperature effects.

Conventionally, gas sensors are proposed in which a heater is combined with a detection element whose physical quantity, such as electrical resistance value, changes depending on the gas concentration, etc. Even in a gas sensor having a heater, however, there is a problem in that the output value of the detection element changes due to environmental changes in humidity or so. Thus, as conventional techniques to deal with the problem of change in output value of detection elements due to environmental changes in humidity or so, for example, techniques to install a humidity detection unit outside an element or to detect humidity by using a humidity-sensitive film are proposed (see Patent Document 1, Patent Document 2, etc.).
Patent Document 1: JP6168919 (B2)
Patent Document 2: JP6218270 (B2)

### SUMMARY

However, the conventional techniques have a problem in that the correction of the detection value by the humidity detection unit, etc. is not sufficient due to the positional and structural difference between the detection element for detecting the gas concentration and the humidity detection unit, etc. It is desirable to provide a gas sensor, etc. capable of accurately performing humidity correction on a detection value of a detection element for detecting a predetermined gas.

A gas sensor according to the present disclosure comprises:
a base member provided with a cavity;
a first insulating film formed above the cavity and on a cavity peripheral portion,
a second insulating film formed so as to overlap with the first insulating film;
a heater section formed between the first insulating film and the second insulating film;
a first compensation element including:
   a first dummy material portion formed in a first formation area on the heater section and the second insulating film at a first position above the cavity, the first dummy material portion being containing a dummy material that does not react with a predetermined gas; and a first compensation detection portion detecting a physical quantity of the first dummy material portion;
a second compensation element including:
   a second dummy material portion formed in a second formation area, different from the first formation area, on the heater section and the second insulating film at a second position above the cavity, the second dummy material portion being containing the dummy material; and
   a second compensation detection portion detecting a physical quantity of the second dummy material portion; and
a detection element including:
   a detection material portion formed on the heater section and the second insulating film at a third position above the cavity, the detection material portion being containing a gas detection material that reacts with the predetermined gas; and
   a reaction detection portion detecting a physical quantity of the detection material portion.

A method of detecting gas according to present disclosure is a method of detecting gas with the above-mentioned gas sensor, comprising the steps of:
calculating a detection value of a virtual third compensation element assumed to be formed in the same third formation area as the reaction detection portion and assumed to contain the dummy material, based on a detection value of the first compensation element, the first formation area, a detection value of the second compensation element, and the second formation area; and
calculating a concentration of the predetermined gas based on a difference between the detection value of the detection element and the detection value of the third compensation element.

### BRIEF DESCRIPTION OF THE DRAWING(S)

FIG. 1 is a schematic plan view of a gas sensor according to First Embodiment of the present disclosure;

FIG. 2 is a schematic cross-sectional view of the gas sensor shown in FIG. 1 along the cross-sectional line II-II;

FIG. 3A is a schematic cross-sectional view of the gas sensor shown in FIG. 1 along the cross-sectional line IIIA-IIIA;

FIG. 3B is a schematic cross-sectional view of the gas sensor shown in FIG. 1 along the cross-sectional line IIIB-IIIB;

FIG. 3C is a schematic cross-sectional view of the gas sensor shown in FIG. 1 along the cross-sectional line IIIC-IIIC;

FIG. 4A and FIG. 4B are a cross-sectional view and a plan view illustrating the shape of a base member of the gas sensor shown in FIG. 1;

FIG. 5A and FIG. 5B are a cross-sectional view and a plan view illustrating the shape of a first insulating film of the gas sensor shown in FIG. 1;

FIG. 6A and FIG. 6B are a cross-sectional view and a plan view illustrating the shape of a heater film in the gas sensor shown in FIG. 1;

FIG. 7A and FIG. 7B are a cross-sectional view and a plan view illustrating the shape of a second insulating film of the gas sensor shown in FIG. 1;

FIG. 8A and FIG. 8B are a cross-sectional view and a plan view illustrating the shape of a detection electrode film in the gas sensor shown in FIG. 1;

FIG. 9A and FIG. 9B are a cross-sectional view and a plan view illustrating the shape of a thermistor film in the gas sensor shown in FIG. 1;

FIG. 10A and FIG. 10B are a cross-sectional view and a plan view illustrating the shape of a terminal electrode film in the gas sensor shown in FIG. 1;

FIG. 11A and FIG. 11B are a cross-sectional view and a plan view illustrating the shapes of a detection material portion, a first dummy material portion, and a second dummy material portion in the gas sensor shown in FIG. 1;

FIG. 12 is a schematic plan view of a gas sensor according to Second Embodiment of the present disclosure;

FIG. 13A is a schematic cross-sectional view of the gas sensor shown in FIG. 12 along the cross-sectional line XIIIA-XIIIA;

FIG. 13B is a schematic cross-sectional view of the gas sensor shown in FIG. 12 along the cross-sectional line XIIIB-XIIIB;

FIG. 13C is a schematic cross-sectional view of the gas sensor shown in FIG. 12 along the cross-sectional line XIIIC-XIIIC;

FIG. 14A is a schematic cross-sectional view of the gas sensor shown in FIG. 12 along the cross-sectional line XIVA-XIVA;

FIG. 14B is a schematic cross-sectional view of the gas sensor shown in FIG. 12 along the cross-sectional line XIVB-XIVB;

FIG. 14C is a schematic cross-sectional view of the gas sensor shown in FIG. 12 along the cross-sectional line XIVC-XIVC;

FIG. 15 is a schematic plan view of a gas sensor according to Third Embodiment of the present disclosure;

FIG. 16 is a schematic cross-sectional view of the gas sensor shown in FIG. 15 along the cross-sectional line XVI-XVI;

FIG. 17A is a schematic cross-sectional view of the gas sensor shown in FIG. 15 along the cross-sectional line XVIIA-XVIIA;

FIG. 17B is a schematic cross-sectional view of the gas sensor shown in FIG. 15 along the cross-sectional line XVIIB-XVIIB;

FIG. 18 is a graph showing changes in the output values of each element of the gas sensor according to First Example;

FIG. 19A to FIG. 19D are graphs showing a calculation process of a difference in resistance value for calculating a gas concentration based on the detection values of each element of the gas sensor according to First Example;

FIG. 20 is a graph comparing a calculation result of the difference in resistance value of the gas sensor according to First Example and a calculation result of the difference in resistance value of the gas sensor according to Reference Example;

FIG. 21A to FIG. 21D are graphs showing a calculation process of a difference in resistance value for calculating a gas concentration based on the detection values of each element of the gas sensor according to Second Example; and

FIG. 22 is a graph comparing a calculation result of the difference in resistance value of the gas sensor according to Second Example and a calculation result of the difference in resistance value of the gas sensor according to Reference Example.

### DETAILED DESCRIPTION

Hereinafter, the present disclosure is described in detail in the following order based on specific embodiments and the like.

### 1. First Embodiment

1.1. Overall Structure
1.2. Base Member
1.3. First and Second Insulating Films
1.4. Heater Film
1.5. Thermistor Film and Detection Electrode Film
1.6. Detection Material Portion and Dummy Material Portion
1.7. Terminal Electrode Film
1.8. Manufacturing Method
1.9. Operation
1.10. Action
2. Second Embodiment
3. Third Embodiment
4. First Example
5. Second Example

### 1. First Embodiment

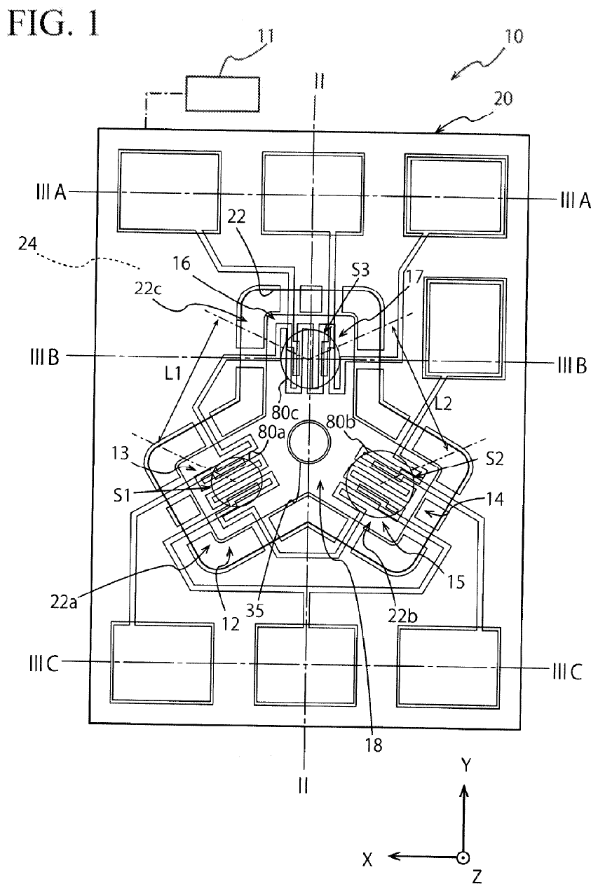

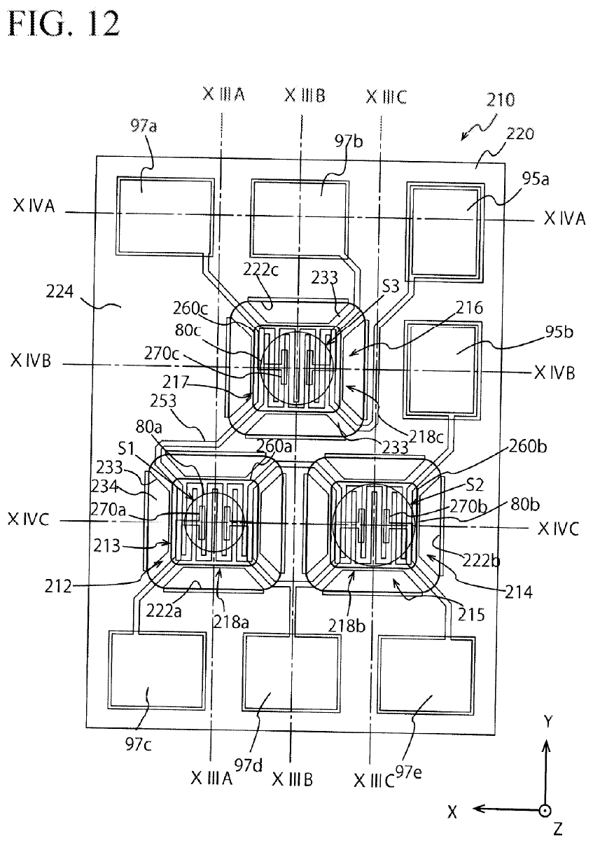

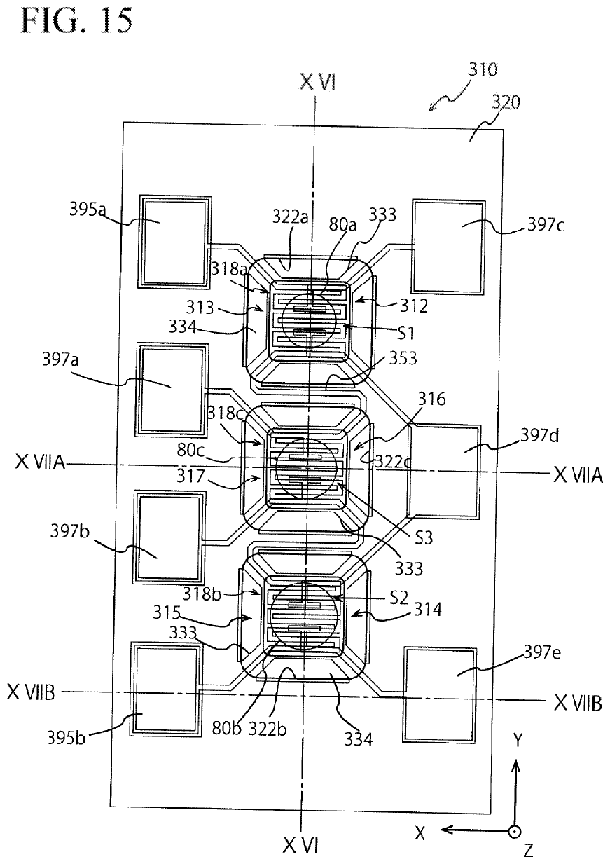

FIG. 1 is a schematic plan view illustrating a gas sensor 10 according to First Embodiment and is a view of the gas sensor 10 viewed from above. The gas sensor 10 has a multilayer structure in which multiple films are laminated in the vertical direction. Note that, in FIG. 1, for convenience of explanation, all films are seen through, and the contour shape of each layer is displayed. The same applies to FIG. 12 and FIG. 15.

### (1.1. Overall Structure)

The gas sensor 10 includes at least three detection sections consisting of a first compensation element 12, a second compensation element 14, and a detection element 16 supported by a membrane 18 with a thin film shape. As described below, among the three detection sections of the gas sensor 10, the detection element 16 has the ability to detect predetermined gases. Gases to be detected by the gas sensor 10 are flammable gases and reducing gases, and their specific examples include carbon monoxide (CO), methane (CH₄), hydrogen (H₂), and ethanol (C₂H₅OH).

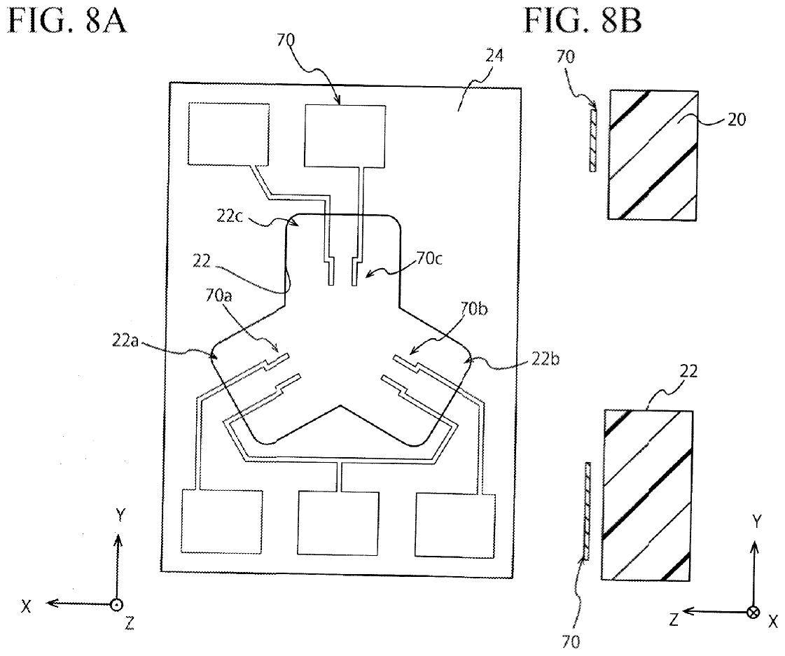

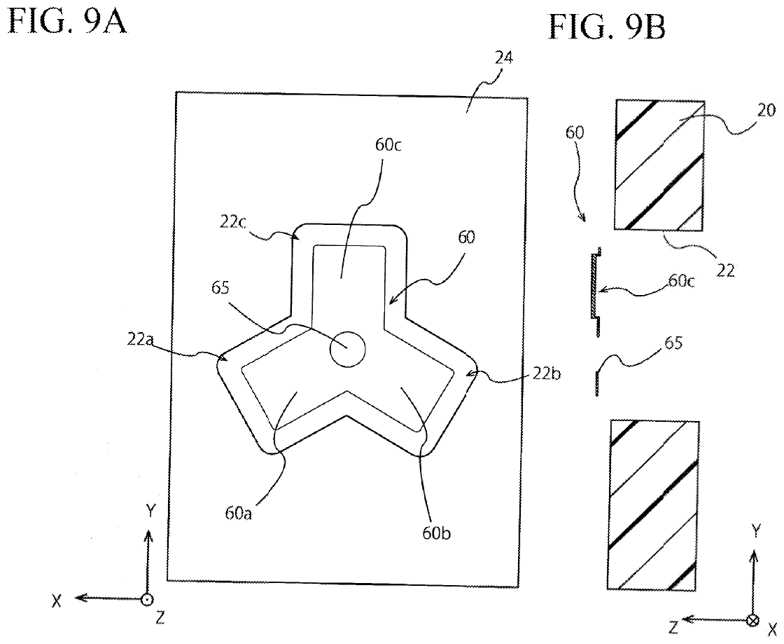

The detection element 16 of the gas sensor 10 includes: a detection material portion 80c containing a gas detection material that reacts with a predetermined gas; and a reaction detection portion 17 for detecting a physical quantity of the detection material portion 80c. As described below, the detection material portion 80c includes: a thermistor-film third portion 60c of a thermistor film 60 (see FIG. 9A) and a detection-electrode third portion 70c of a detection electrode film 70 (see FIG. 8A). The reaction detection portion 17 detects a physical quantity caused by the reaction with the gas of the detection material portion 80c which appears as heat generation and endothermy, as a resistance change of the thermistor-film third portion 60c of the thermistor film 60 via the detection-electrode third portion 70c. Since the detection-electrode third portion 70c can easily detect a resistance change of the thermistor-film third portion 60c when the gas to be detected has a high concentration, the reaction detection portion 17 using the thermistor film 60 and the detection electrode film 70 are particularly favorable for detection when the gas to be detected has a high concentration.

The gas detection material contained in the detection material portion 80c is not limited as long as it is a known material as a catalyst for a gas sensor and is normally one in which noble metal particles are supported on a carrier. Examples of the carrier include oxide materials such as aluminum oxide (y alumina, etc.) and silicon oxide. Examples of the noble metal particles supported on a carrier include noble metal particles such as platinum (Pt), palladium (Pd), ruthenium (Ru), and rhodium (Rh).

Note that, the detection element 16 according to the present disclosure is not limited to only a combination of the detection material portion 80c containing the gas detection material and the reaction detection portion 17 including the thermistor film 60 and the detection electrode film 70. Examples of other detection elements include a combination of the detection material portion 80c containing the gas detection material and a reaction detection portion having a Pt wire and a combination of a semiconductor material as the gas detection material and a reaction detection portion having a detection electrode for detecting a resistance of the semiconductor material.

The detection element 16 includes the detection material portion 80c containing a gas detection material that reacts with a predetermined gas, whereas the first compensation element 12 includes a first dummy material portion 80a containing a dummy material that does not react with a predetermined gas, and the second compensation element 14 includes a second dummy material portion 80b containing a dummy material that does not react with a predetermined gas. Also, the first compensation element 12 includes a first compensation detection portion 13 for detecting a physical quantity of the first dummy material portion 80a, and the second compensation element 14 includes a second compensation detection portion 15 for detecting a physical quantity of the second dummy material portion 80b.

The dummy materials contained in the first dummy material portion 80a and the second dummy material portion 80b are not limited as long as they do not have electrical or thermal reactivity to a predetermined gas at least within the operating condition range of the gas sensor 10. Preferably, physical properties of the dummy materials excluding reactivity to gas, such as mass and thermal conductivity, are similar to those of the gas detection material contained in the detection material portion 80c. Note that, the dummy material having no reactivity to a predetermined gas includes those that have a sufficiently low reactivity or slight reactivity compared to that of the gas detection material, in addition to those that do not have reactivity at all to a predetermined gas. Also, the dummy materials contained in the first dummy material portion 80a and the second dummy material portion 80b are preferably the same material, but are not limited to only the same material.

Here, the detection value of the reaction detection portion 17 included in the detection element 16 of the gas sensor 10 includes influences of environmental changes other than the concentration of a predetermined gas to be detected, such as temperature and humidity. In addition to the reaction detection portion 17, however, the gas sensor 10 includes the first compensation element 12 and the second compensation element 14 using the first compensation detection portion 13 and the second compensation detection portion 15 containing a dummy material that does not react with a predetermined gas. Thus, due to the first compensation element 12 and the second compensation element 14, the gas sensor 10 can accurately detect how environmental changes other than the concentration of the predetermined gas to be detected affect the detection value of the detection element 16.

Also, the gas sensor 10 can accurately detect the gas concentration by detecting the influences of environmental changes other than the concentration of a predetermined gas to be detected on the detection value using the first compensation detection portion 13 and the second compensation detection portion 15 and removing the influences of environmental changes other than the concentration of the predetermined gas from the detection value of the reaction detection portion 17 for detecting the predetermined gas. For example, the gas sensor 10 includes a humidity correction portion 11 as shown in FIG. 1. The humidity correction portion 11 performs a humidity correction of the detection value of the reaction detection portion 17 using the detection values of the first compensation detection portion 13 and the second compensation detection portion 15.

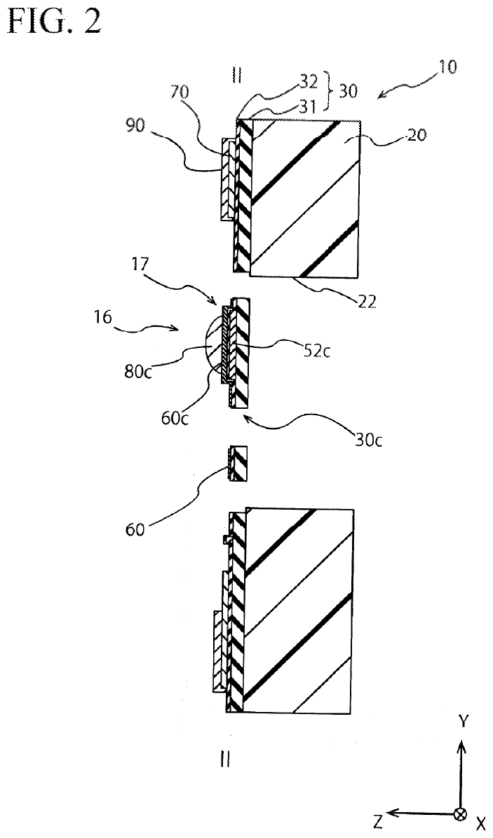

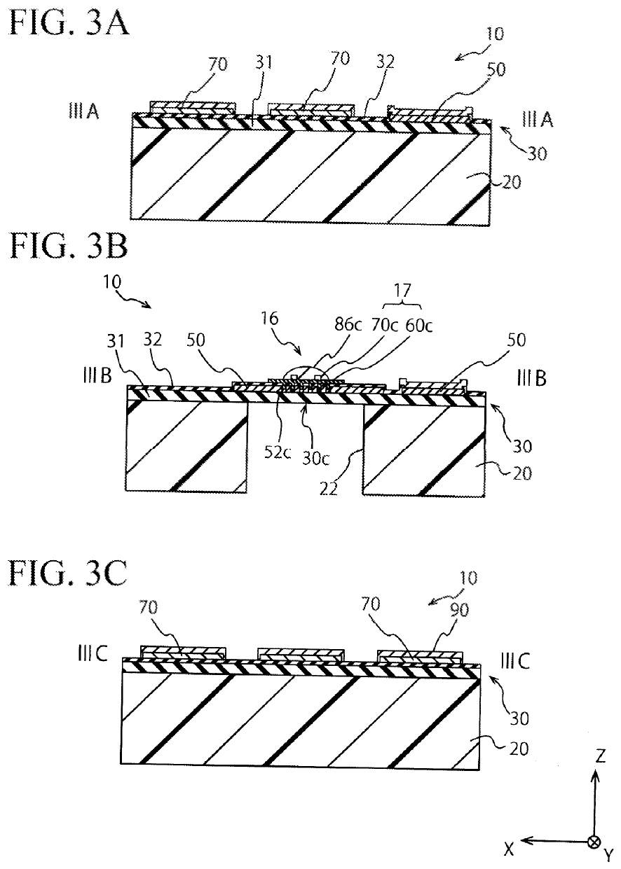

FIG. 2 is a schematic cross-sectional view of the gas sensor 10 taken along a plane along the line II-II in FIG. 1. FIG. 3A is a schematic cross-sectional view of the gas sensor 10 taken along a plane along the line IIIA-IIIA in FIG. 1, FIG. 3B is a schematic cross-sectional view of the gas sensor 10 taken along a plane along the line IIIB-IIIB in FIG. 1, and FIG. 3C is a schematic cross-sectional view of the gas sensor 10 taken along a plane along the line IIIC-IIIC in FIG. 1. Note that, in the description of the gas sensor 10, the vertical direction of the gas sensor 10 is referred to as the Z-axis, the direction perpendicular to the Z-axis and connecting the center position of the membrane 18 and the center position of the detection element 16 is referred to as the Y-axis, and the direction perpendicular to the Z-axis and Y-axis is referred to as the X-axis. Note that, the Z-axis direction of the gas sensor 10 coincides with the lamination direction of a first insulating film 31, a second insulating film 32, and the like described below. Moreover, in the description of the gas sensor 10, the side from a base member 20 to the first insulating film 31 and the second insulating film 32 is referred to as the upper side and the positive side in the Z-axis direction, and the opposite side to the upper side and the positive side in the Z-axis direction is referred to as the lower side and the negative side in the Z-axis direction.

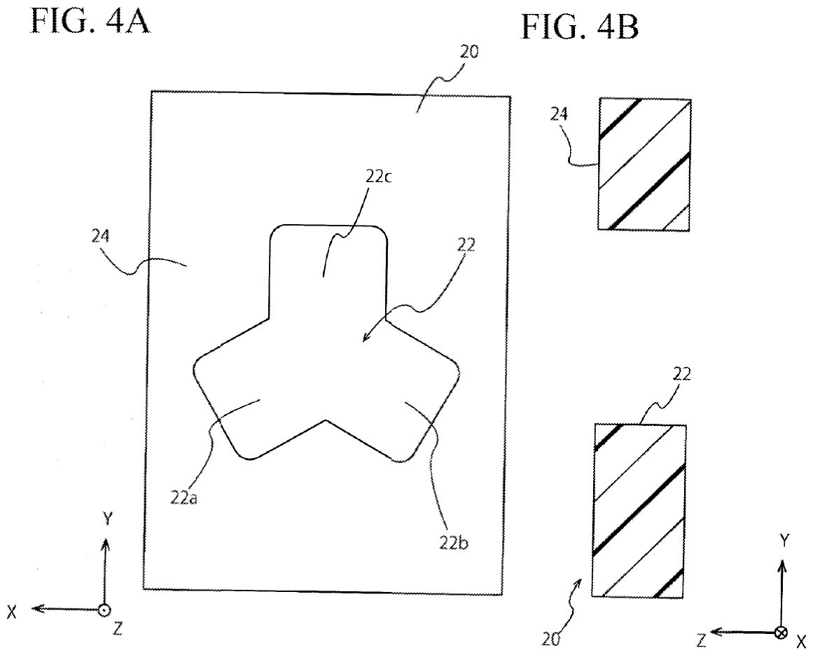

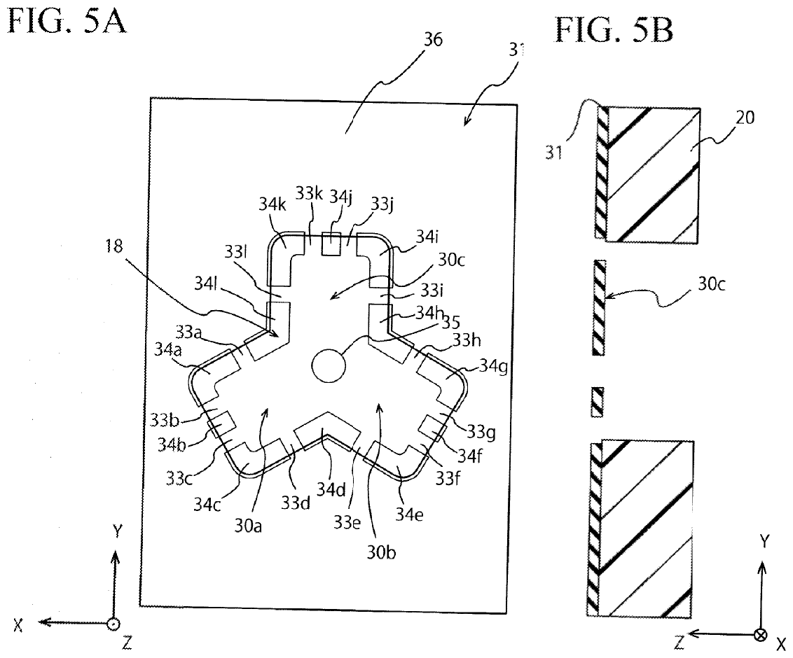

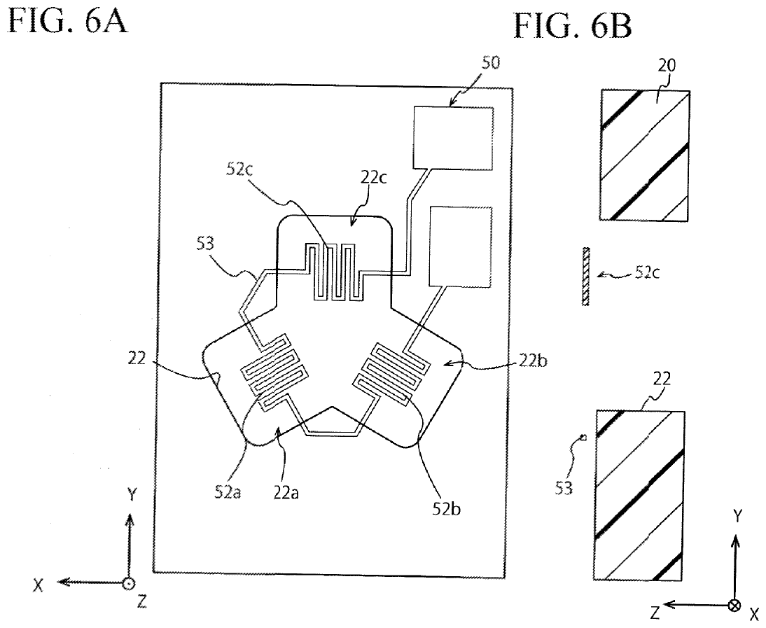

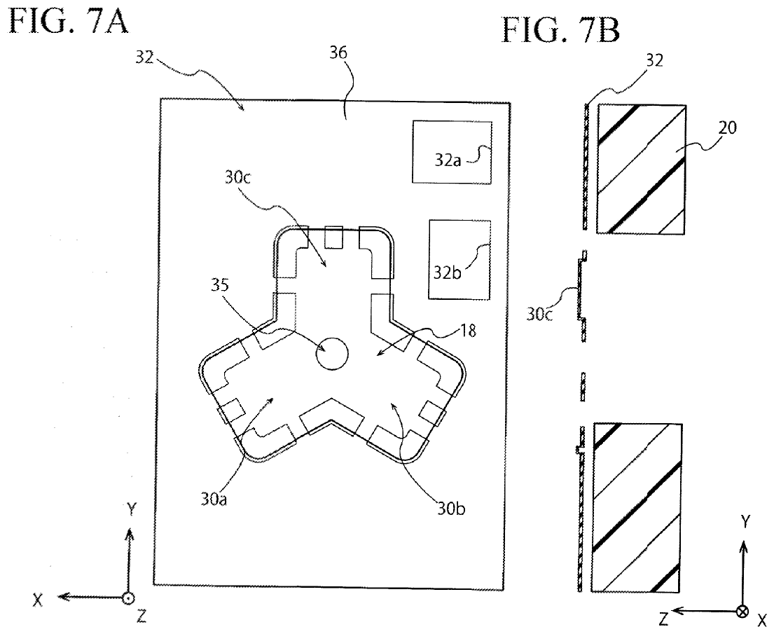

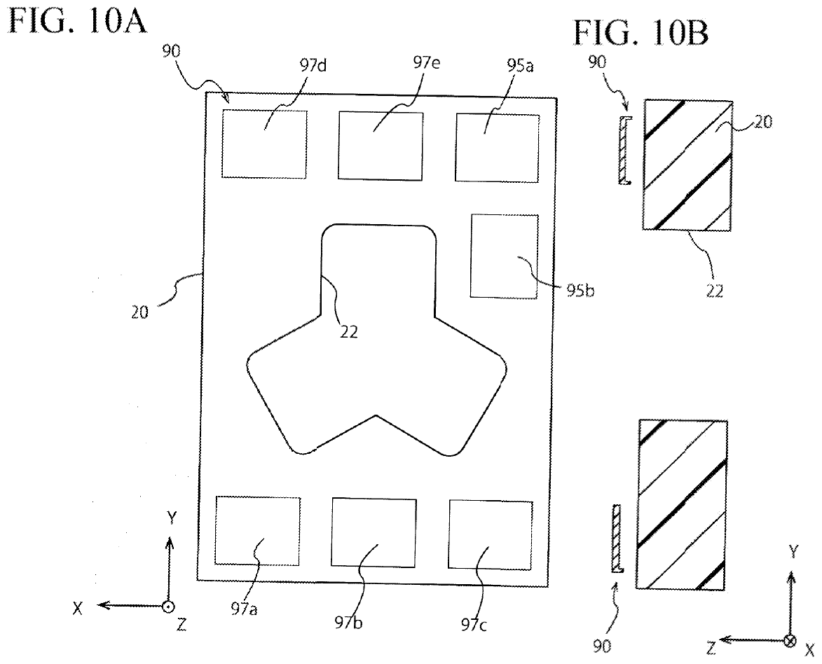

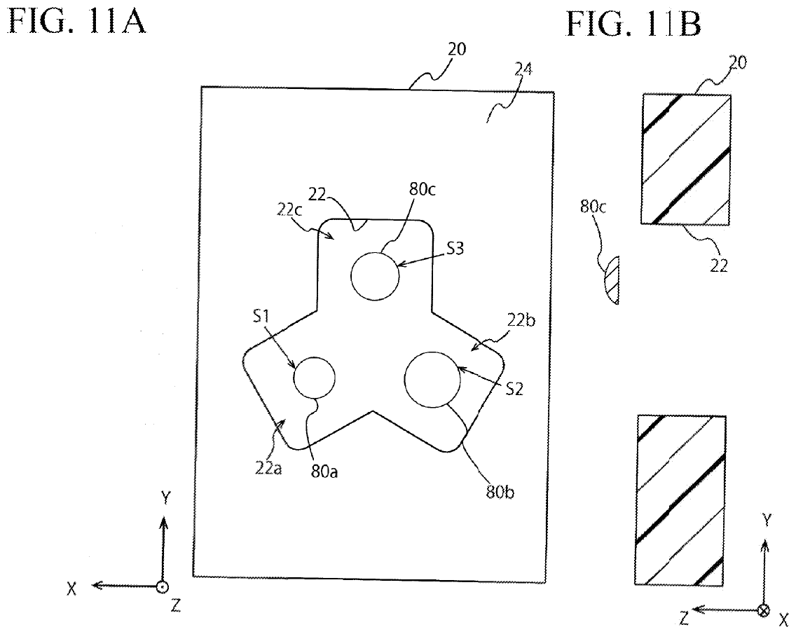

FIG. 4A and FIG. 4B are a plan view and a cross-sectional view showing the base member 20 of the gas sensor 10. As shown in FIG. 1 to FIG. 4B, the gas sensor 10 includes the base member 20 provided with a cavity 22. As shown in FIG. 2 and FIG. 3A to FIG. 3C, other members of the gas sensor 10 excluding the base member 20 are arranged above the cavity 22 of the base member 20 and on a cavity peripheral portion 24 as a peripheral portion of the cavity 22. Other members excluding the base member 20 included in the gas sensor 10 include the first insulating film 31 (FIG. 5A and FIG. 5B), the second insulating film 32 (FIG. 7A and FIG. 7B), a heater film 50 (FIG. 6A and FIG. 6B), the detection electrode film 70 (FIG. 8A and FIG. 8B), the thermistor film 60 (FIG. 9A and FIG. 9B), a terminal electrode film 90 (FIG. 10A and FIG. 10B), the first dummy material portion 80a, the second dummy material portion 80b, the detection material portion 80c (FIG. 11A and FIG. 11B), and the like. In the gas sensor 10, the first compensation detection portion 13, the second compensation detection portion 15, and the reaction detection portion 17 are configured by combining the members formed above the cavity 22.

### (1.2. Base Member)

As shown in FIG. 4A, the cavity 22 is formed around the center of the base member 20. As shown in FIG. 4A, which is a plan view of the base member 20, the cavity 22 has a substantially Y shape in a plan view. As shown in FIG. 1, the membrane 18 is disposed above the cavity 22. As shown in FIG. 4B, which is a cross-sectional view, the cavity 22 is made of a through hole formed in the base member 20.

However, the cavity 22 is not limited to only a through hole as shown in FIG. 2 and FIG. 3A to FIG. 3C, and the cavity 22 may be made of a concaved portion concaved downward from the cavity peripheral portion 24 on the substrate surface side.

As can be understood from the comparison between FIG. 1 and FIGS. 4A and 4B, the cavity 22 of the base member 20 is an integrated cavity where the detection element 16, the first compensation element 12, and the second compensation element 14 are arranged above. That is, the detection element 16, the first compensation element 12, and the second compensation element 14 are arranged in a continuous cavity that is not separated from each other by the cavity peripheral portion 24.

The material of the base member 20 is not limited as long as it has a sufficient mechanical strength so as to support the members formed above the cavity 22 and on the peripheral portion 24 and is suitable for microfabrication such as etching. In the present embodiment, examples of the base member 20 include a silicon single crystal substrate, a sapphire single crystal substrate, a ceramic substrate, a quartz substrate, a glass substrate, and a ferrite substrate.

### (1.3. First and Second Insulating Films)

FIG. 5A is a plan view of the first insulating film 31 and the base member 20, and FIG. 5B is a cross-sectional view of the first insulating film 31 and the base member 20. FIG. 7A is a plan view of the second insulating film 32 and the base member 20, and FIG. 7B is a cross-sectional view of the second insulating film 32 and the base member 20.

As shown in FIG. 1, FIG. 2, and FIGS. 5A and 5B, the first insulating film 31 is formed on the upper side of the cavity 22 formed in a central part of the base member 20 and on the upper side of the cavity peripheral portion 24 constituting the upper surface of the base member 20. As shown in FIG. 5A, the first insulating film 31 is formed on the entire upper side of the base member 20 other than the portions corresponding to peripheral hole portions 34a to 34l formed around the outer peripheral portion of the cavity 22 and the portion corresponding to a central hole portion 35 formed at the center of the membrane 18.

As shown in FIG. 1, FIG. 2, and FIGS. 7A and 7B, the second insulating film 32 is formed so as to overlap with the first insulating film 31. As shown in FIG. 7A, the second insulating film 32 is formed on the entire upper side of the base member 20 other than the portions corresponding to the peripheral hole portions 34a to 34l formed around the outer peripheral portion of the cavity 22, the central hole portion 35 formed at the center of the membrane 18, and through holes 32a and 32b provided with heater terminals 95a and 95b on the cavity peripheral portion 24.

As can be understood from the comparison between FIG. 5A and FIG. 7A, the first insulating film 31 and the second insulating film 32 have substantially the same planar shape, except that the second insulating film 32 is provided with the through holes 32a and 32b in the portions where the heater terminals 95a and 95b (see FIG. 10A and FIG. 10B) are formed. As shown in FIG. 2, the insulating film 30 is made of the first insulating film 31 and the second insulating film 32. However, the second insulating film 32 is not limited to only the shape shown in the embodiment, and the planar shape of the second insulating film 32 does not necessarily correspond with the planar shape of the first insulating film 31.

A portion of the insulating film 30 disposed above the cavity 22 constitutes the membrane 18 in the gas sensor 10. A portion of the insulating film 30 disposed on the cavity peripheral portion 24 is an insulating-film peripheral portion 36. As shown in FIG. 1, FIG. 5A, and FIG. 7A, the insulating film 30 includes a plurality (10 in the embodiment) of beam portions 33a to 33l connecting the membrane 18 and the insulating-film peripheral portion 36. As shown in FIG. 2, a hollow space of the cavity 22 is provided below the membrane 18, but the membrane 18 is held above the cavity 22 via the beam portions 33a to 33l. Also, as shown in FIG. 1, the insulating film 30 is provided with peripheral hole portions 34a to 34l between any two of the beam portions 33a to 33l.

As shown in FIG. 1, FIG. 5A, and FIG. 7A, the peripheral hole portions 34a to 34l are formed around the membrane 18 in the insulating film 30 so as to surround the membrane 18. Each of the peripheral hole portions 34a to 34l is disposed between any two of the beam portions 33a to 33l. Thus, the peripheral hole portions 34a to 34l and the beam portions 33a to 33l are alternately arranged around the membrane 18 so as to surround the membrane 18. Thus, the membrane 18 is supported to the base member 20 via the beam portions 34a to 34l, etc. having a small cross-sectional area in a cross section perpendicular to the XY plane.

In such a gas sensor 10, as shown in FIG. 1, the heat capacity of substances other than the detection material portion 80c, the first dummy material portion 80a, and the second dummy material portion 80b can be reduced in the vicinity of the reaction detection portion 17, the first compensation detection portion 13, and the second compensation detection portion 15 arranged on the membrane 18. Due to the structure of the membrane 18 supported by the beam portions 33a to 33l, the detection element 16, the first compensation element 12, the second compensation element 14, and the like arranged on the membrane 18 have the structure favorably insulated to the base member 20 supporting the membrane 18. Such a gas sensor 10 can extremely reduce the power consumption of a heater first portion 52a, a heater second portion 52b, and a heater third portion 52c (see FIG. 6A and FIG. 6B) necessary for heating the detection element 16, the first compensation element 12, and the second compensation element 14 to a predetermined temperature.

In the insulating film 30 made of the first insulating film 31 and the second insulating film 32, an insulating-film first portion 30a as a portion located at a first position 22a, an insulating-film second portion 30b as a portion located at a second position 22b, and an insulating-film third portion 30c as a portion located at a third position 22c form the membrane 18 as an integrated membrane connected to each other without the insulating-film peripheral portion 36, which is a portion fixed to the cavity peripheral portion 24. Here, as shown in FIG. 1, the first position 22a is a position above the cavity 22 where the first dummy material portion 80a is formed, the second position 22b is a position above the cavity 22 where the first dummy material portion 80b is formed, and the third position 22c is a position above the cavity 22 where the detection material portion 80c is formed.

As shown in FIG. 1, similarly to the cavity 22, the membrane 18 has a substantially Y shape in plan view. As shown in FIG. 5A, the central hole portion 35 as a through hole is formed at the center of the membrane 18, and the positive side of the central hole portion 35 in the Y-axis direction is the insulating-film third portion 30c. Also, the insulating-film first portion 30a is located at a position obtained by rotating the insulating-film third portion 30c approximately 120 degrees counterclockwise around the central hole portion 35, and the insulating-film second portion 30b is located at a position obtained by rotating the insulating-film third portion 30c approximately 120 degrees clockwise around the central hole portion 35.

In the gas sensor 10, as shown in FIG. 1, FIG. 5A, and FIG. 7A, since the insulating-film first portion 30a, the insulating-film second portion 30b, and the insulating-film third portion 30c form an integrated membrane, it is possible to reduce the difference in conditions between the detection element 16, the first compensation element 12, and the second compensation element 14. Thus, the gas sensor 10 can accurately remove the influence of environmental changes other than the concentration of the predetermined gas from the detection value of the reaction detection portion 17 included in the detection element 16 and effectively improve the gas detection accuracy.

Also, in the gas sensor 10, since the central hole portion 35 is formed, it is possible to reduce the temperature interference between the elements 12, 14, and 16, and there is a reduction effect on stress caused by expansion and contraction due to thermal expansion.

The thicknesses of the first insulating film 31 and the second insulating film 32 are not limited, but as shown in FIG. 2, the thickness of the first insulating film 31 is preferably larger than the thickness of the second insulating film 32 from the viewpoint of efficiently transmitting the heat of the heater first portion 52a, the heater second portion 52b, and the heater third portion 52c to the first compensation element 12, the second compensation element 14, and the detection element 16 while ensuring the strength of the membrane 18. The thickness of the first insulating film 31 is preferably, for example, 0.1 to 10 μm and is more preferably, for example, 0.5 to 5 μm. Also, the thickness of the second insulating film 32 is preferably, for example, 0.1 to 5 μm and is more preferably, for example, 0.2 to 2 μm.

The materials of the first insulating film 31 and the second insulating film 32 are determined in consideration of durability against thermal stress, mechanical strength, film stress, adhesion, electrical insulation, etc. and include silicon oxide, silicon nitride, aluminum oxide, ditantalum pentoxide, or the like. The materials of the first insulating film 31 and the second insulating film 42 may be the same or different from each other. Also, the first insulating film 31 and the second insulating film 32 may be a multilayer film of the above-mentioned materials.

### (1.4. Heater Film)

As shown in FIG. 1 and FIG. 2, the heater first portion 52a, the heater second portion 52b, and the heater third portion 52c as the heater section formed by the heater film 50 and a part of the heater film 50 are arranged between the first insulating film 31 and the second insulating film 32 in the vertical direction.

FIG. 6A is a plan view of the heater film 50 and the cavity 22, and FIG. 6B is a cross-sectional view of the heater film 50 and the cavity 22. As shown in FIG. 6A, the heater film 50 includes the heater first portion 52a, the heater second portion 52b, and the heater third portion 52c arranged above the cavity 22. In the heater first portion 52a, the heater second portion 52b, and the heater third portion 52c, the heater film 50 has an elongated rectangular wave shape (meander pattern).

The heater first portion 52a, the heater second portion 52b, and the heater third portion 52c are arranged at the first position 22a, the second position 22b, and the third position 22c above the cavity 22, respectively. The heater first portion 52a, the heater second portion 52b, and the heater third portion 52c constituting the heater section are wired to the cavity peripheral portion 24 via a heater-film wiring portion 53 as another portion of the heater film 50.

The heater first portion 52a, the heater second portion 52b, and the heater third portion 52c generate Joule heat when energized and increase the temperatures of the first compensation element 12, the second compensation element 14, and the detection element 16. For example, as shown in FIG. 2, the heater third portion 52c heats the reaction detection portion 17 and the detection material portion 80c arranged on the upper side via the second insulating film 32. Likewise, the heater first portion 52a and the heater second portion 52b also heat: the first compensation detection portion 13 and the first dummy material portion 80a; and the second compensation detection portion 15 and the second dummy material portion 80b (see FIG. 1).

The heater first portion 52a, the heater second portion 52b, and the heater third portion 52c are connected in series to each other via the beam portions 33a, 33d, 33e, 33h, 33i, and 33l of the insulating film 30. The wiring of the heater first portion 52a, the heater second portion 52b, and the heater third portion 52c is not limited to only the mode of the series connection as shown in FIG. 6 and may be a mode where the heater first portion 52a, the heater second portion 52b, and the heater third portion 52c are wired independently.

The material of the heater film 50 is not limited as long as it is electrically conductive, but is preferably a material having a comparatively high melting point from the viewpoint of enabling a high temperature process in the formation steps of the first compensation element 12, the second compensation element 14, and the detection element 16. Examples of such a material include molybdenum (Mo), platinum (Pt), nickel chromium alloy (NiCr), tungsten (W), tantalum (Ta), palladium (Pd), iridium (Ir), and alloys containing two or more of them.

### (1.5. Detection Electrode Film and Thermistor Film)

FIG. 8A is a plan view of the detection electrode film 70 and the base member 20, and FIG. 8B is a cross-sectional view of the detection electrode film 70 and the base member 20. Also, FIG. 9A is a plan view of the thermistor film 60 and the base member 20, and FIG. 9B is a cross-sectional view of the thermistor film 60 and the base member 20.

The thermistor film 60 and the detection electrode film 70 are formed on the second insulating film 32. In the gas sensor 10, as shown in FIG. 3B, the detection electrode film 70 (detection-electrode third portion 70c) is formed on the thermistor film 60 (thermistor-film third portion 60c). However, the vertical relation between the thermistor film 60 and the detection electrode film 70 is not limited to one shown in the embodiment, and the thermistor film 60 may be formed on the detection electrode film 70 (the detection-electrode third portion 70c).

The portions of the thermistor film 60 and the detection electrode film 70 constitute the first compensation detection portion 13, the second compensation detection portion 15, and the reaction detection portion 17 shown in FIG. 1. As shown in FIG. 9, the thermistor film 60 is disposed above the cavity 22 and has a substantially Y outer shape similar to that of the membrane 18 in plan view. In a central part of the thermistor film 60, a thermistor central hole portion 65 as a through hole is formed at a position overlapping with the central hole portion 35 of the membrane 18.

As shown in FIG. 9A, the thermistor film 60 includes: a thermistor-film first portion 60a located at the first position 22a above the cavity 22, a thermistor-film second portion 60b located at the second position 22b above the cavity 22, and a third-thermistor film portion 60c located at the third position 22c above the cavity 22. The thermistor-film first portion 60a, the thermistor-film second portion 60b, and the thermistor-film third portion 60c are connected to each other on the membrane 18. However, the thermistor-film first portion 60a, the thermistor-film second portion 60b, and the thermistor-film third portion 60c only need to be formed so as to overlap with a detection-electrode first portion 70a, a detection-electrode second portion 70b, and a detection-electrode third portion 70c shown in FIG. 8, respectively, and may be separated from each other.

As shown in FIG. 8A, the detection electrode film 70 includes: the detection-electrode first portion 70a located at the first position 22a above the cavity 22; the detection-electrode second portion 70b located at the second position 22b above the cavity 22; and the detection-electrode third portion 70c located at the third position 22c above the cavity 22.

The detection-electrode first portion 70a, the detection-electrode second portion 70b, and the detection-electrode third portion 70c are wired to the cavity peripheral portion 24 via a detection-electrode-film wiring portion as another portion of the detection electrode film 70. The detection-electrode first portion 70a, the detection-electrode second portion 70b, and the detection-electrode third portion 70c are independently wired to the cavity peripheral portion 24 via the beam portions 33b and 33c of the insulating film 30, the beam portions 33f and 33g of the insulating film 30, and the beam portions 33j and 33k of the insulating film 30, respectively. The detection signals of the detection-electrode first portion 70a, the detection-electrode second portion 70b, and the detection-electrode third portion 70c are transmitted to the humidity correction portion 11 shown in FIG. 1, a control calculation portion not shown, etc. Note that, one electrode of the detection-electrode first portion 70a and one electrode of the detection-electrode second portion 70b are connected to GND and thus combined into one wiring, but the wiring of the detection electrode film 70 is not limited to only the example shown in FIG. 8A.

The detection-electrode first portion 70a, the detection-electrode second portion 70b, and the detection-electrode third portion 70c detect a resistance change (mainly, due to temperature changes) of the thermistor-film first portion 60a, the thermistor-film second portion 60b, and the thermistor-film third portion 60c in contact with the detection-electrode first portion 70a, the detection-electrode second portion 70b, and the detection-electrode third portion 70c, respectively. As shown in FIG. 3B, the thermistor-film third portion 60c is in contact with the detection material portion 80c formed on the thermistor-film third portion 60c at the third position 22c. Thus, the detection-electrode third portion 70c can detect a thermal change accompanying a reaction with a predetermined gas in the detection material portion 80c by detecting a resistance change of the thermistor-film third portion 60c.

Similarly to the detection-electrode third portion 70c, the detection-electrode first portion 70a and the detection-electrode second portion 70b can detect resistance changes of the thermistor-film first portion 60a and the thermistor-film second portion 60b by detecting resistance changes of the thermistor-film first portion 60a and the thermistor-film second portion 60b. Since the first dummy material portion 80a and the second dummy material portion 80b have a dummy material that does not react with the predetermined gas, changes in the environment other than the influences of increases and decreases in the concentration of the gas to be measured can be detected in the detection-electrode first portion 70a and the detection-electrode second portion 70b.

The material of the detection electrode film 70 shown in FIG. 8 can be a conductor such as metal and includes, for example, gold (Au), silver (Ag), platinum (Pt), and aluminum (Al). The material constituting the thermistor film 60 shown in FIG. 9 is not limited as long as it can be used as a thermistor film whose resistance value changes due to temperature changes, and examples of the material constituting the thermistor film 60 shown in FIG. 9 include a composite metal oxide containing metal elements such as manganese (Mn), nickel (Ni), cobalt (Co), and iron (Fe).

### (1.6. Detection Material Portion and Dummy Material Portion)

FIG. 11A is a plan view of the detection material portion 80c, the first dummy material portion 80a, the second dummy material portion 80b, and the base member 20, and FIG. 8B is a cross-sectional view of the detection material portion 80 and the base member 20. As shown in FIG. 1 and FIG. 3B, the detection material portion 80c is formed on the second insulating film 32 in the heater third portion 52c and the insulating-film third portion 30c at the third position 22c above the cavity 22. Specifically, the detection material portion 80c is formed on the reaction detection portion 17 so as to overlap with the reaction detection portion 17 formed on the insulating-film third portion 30c.

As shown in FIG. 1 and FIG. 3B, the reaction detection portion 17 and the detection material portion 80c formed on the insulating-film third portion 30c constitute the detection element 16 at the third position 22c above the cavity 22.

As shown in FIG. 1 and FIG. 8A, the first dummy material portion 80a is formed on the second insulating film 32 in the heater first portion 52a and the insulating-film first portion 30a at the first position 22a above the cavity 22. Similarly to the detection material portion 80c, the first dummy material portion 80a is formed on the first compensation detection portion 13 so as to overlap with the first compensation detection portion 13 formed on the insulating-film first portion 30a.

Also, the second dummy material portion 80b is formed on the second insulating film 32 in the heater second portion 52b and the insulating-film second portion 30b at the second position 22b above the cavity 22. Similarly to the detection material portion 80c and the first dummy material portion 80a, the second dummy material portion 80b is formed on the second compensation detection portion 15 so as to overlap with the second compensation detection portion 15 formed on the insulating-film second portion 30b.

As shown in FIG. 1, the first compensation detection portion 13 and the first dummy material portion 80a formed on the insulating-film first portion 30a constitute the first compensation element 12 at the first position 22a above the cavity 22. Also, the second compensation detection portion 15 and the second dummy material portion 80b formed on the insulating-film second portion 30b constitute the second compensation element 14.

As shown in FIG. 11A, a first formation area S1, which is a formation area of the first dummy material portion 80a, and a second formation area S2, which is a formation area of the second dummy material portion 80b, are different from each other. That is, the first dummy material portion 80a is formed in the first formation area S1, and the second dummy material portion 80b is formed in the second formation area S2 different from the first formation area S1. The gas sensor 10 includes the first compensation element 12 and the second compensation element 14 including the first and second dummy material portions 80a and 80b having different formation areas and can thereby reduce correction errors caused by manufacturing variations in the formation areas of the detection material portion 80c or the dummy material portions 80a and 80b.

Also, the detection material portion 80c is formed in a third formation area S3. Preferably, the third formation area S3 is larger than either one of the first formation area S1 and the second formation area S2 and smaller than the other of the first formation area S1 and the second formation area S2. In the gas sensor 10 shown in FIG. 1 and FIG. 11A, the third formation area S3 of the detection material portion 80c is larger than the first formation area S1 of the first dummy material portion 80a and smaller than the second formation area S2 of the second dummy material portion 80b.

Such a gas sensor 10 can more accurately remove the influence of environmental changes other than the concentration of a predetermined gas from the detection value of the detection element 16 for detecting the predetermined gas and effectively improve the gas detection accuracy. Note that, the first to third formation areas S1 to S3 are determined by areas of the first dummy material portion 80a, the second dummy material portion 80b, and the detection material portion 80c when the gas sensor 10 is viewed from above in plan as shown in FIG. 1 and FIG. 11A.

Preferably, as shown in FIG. 1, a first distance L1 between the detection element 16 and the first compensation element 12 and a second distance L2 between the detection element 16 and the second compensation element 14 are substantially equal to each other from the viewpoint of reducing the difference in positional conditions between the first compensation element 12 and the second compensation element 14. For the same reason, preferably, a line connecting the center position of the detection element 16, the center position of the first compensation element 12, and the center position of the second compensation element 14 forms a substantially equilateral triangle.

The gas detection material contained in the detection material portion 80c includes a material in which noble metal particles such as platinum (Pt), palladium (Pd), ruthenium (Ru), and rhodium (Rh) are supported on a carrier such as aluminum oxide (γ alumina, etc.) and silicon oxide. The dummy material contained in the first dummy material portion 80a and the second dummy material portion 80b includes aluminum oxide (γ alumina, etc.), silicon oxide, etc.

### (1.7. Terminal Electrode Film)

FIG. 10A is a plan view of the terminal electrode film 90 and the base member 20, and FIG. 10B is a cross-sectional view of the terminal electrode film 90 and the base member 20. As shown in FIG. 10, the terminal electrode film 90 is formed on the cavity peripheral portion 24 of the base member 20. In the cavity peripheral portion 24, the terminal electrode film 90 includes the heater terminals 95a and 95b formed so as to overlap with the heater film 50 and electrode terminals 97a to 97e formed so as to overlap with the detection electrode film 70.

As shown in FIG. 10A, the terminal electrode film 90 is provided so as to overlap with the heater film 50 and the detection electrode film 70 in the cavity peripheral portion 24 of the base member 20 and be in contact with the heater film 50 and the detection electrode film 70. As shown in FIG. 1, the heater terminals 95a and 95b and the electrode terminals 97a to 97e as each portion of the terminal electrode film 90 are exposed to the upper side of the gas sensor 10 and connected with an external wiring.

The material of the terminal electrode film 90 is not limited as long as it is a good conductor and includes gold (Au), silver (Ag), platinum (Pt), aluminum (Al), etc. Preferably, from the viewpoint of bondability to the external wiring, etc., the material of the terminal electrode film 90 is gold (Au). For the purpose of obtaining adhesion with other films, the terminal electrode film 90 may have a base film of titanium (Ti), chromium (Cr), etc.

### (1.8. Manufacturing Method)

Hereinafter, a method of manufacturing the gas sensor 10 is described. However, the method of manufacturing the gas sensor 10 is not limited to the following manufacturing method. First, in the manufacture of the gas sensor 10, a material of a base member as a raw material for a base member 20 is prepared. The material of the base member has a flat plate shape in which a cavity 22 is not formed. Next, a first insulating film 31 (FIG. 5A and FIG. 5B) is formed on one main surface of the material of the base member (a surface to be a cavity peripheral portion 24 after the cavity 22 is formed). The method of forming the first insulating film 31 is a known film forming method, such as a thermal oxidation method and a chemical vapor deposition (CVD) method.

A heater film 50 (FIG. 6A) is formed on the first insulating film 30. The shapes of a heater first portion 52a, a heater second portion 52b, and a heater third portion 52c are formed by, for example, a lift-off method. In the lift-off process, first, a resist is applied to the entire surface on which a predetermined pattern is to be formed, and the resist is exposed and developed to form a predetermined pattern shape. The development dissolves the resist corresponding to the predetermined pattern shape, and the predetermined pattern shape is patterned. After the resist is dissolved, a film of a material constituting the pattern is formed by a film forming method, such as sputtering and vapor deposition. After the film is formed, the remaining resist is removed with a stripping solution, Thus, the film of the material formed on the resist is also removed, the material of the film is left only in the patterned area, and a predetermined pattern is formed.

After the heater film 50 is formed, a second insulating film 40 is formed by a known film forming method as in the formation of the first insulating film 31 so that the heater film 50 is covered other than portions where heater terminals 95a and 95b (FIG. 10A) are formed.

Next, a first compensation detection portion 13, a second compensation detection portion 15, and a reaction detection portion 17 are formed on the second insulating film 40. In the formation process of the first compensation detection portion 13, the second compensation detection portion 15, and the reaction detection portion 17, first, a thermistor film 60 (FIG. 9A and FIG. 9B) is formed on an insulating film 30, and a detection electrode film 70 (FIG. 8A and FIG. 8B) is then formed on the thermistor film 60. The thermistor film 60 and the detection electrode film 70 can be formed by sputtering, vapor deposition, etc., and the detection electrode film 70 can be patterned by a lift-off method similar to that of the heater film 50.

Next, a terminal electrode film 90 (FIG. 10A and FIG. 10B) is formed on a cavity peripheral portion 24 provided with the detection electrode film 70, etc. The detection electrode film 70 can be formed by sputtering, vapor deposition, etc.

Next, among the main surfaces of the material of the base member, an etching mask is applied to a predetermined region on a main surface on which the first insulating film 31, etc. is not formed, and a cavity 22 is formed by etching the material of the base member until the first insulating film 31 formed on the main surface on the opposite side is exposed. The first insulating film 31 and the second insulating film 32 corresponding to the region where the cavity 22 is formed is a membrane 18 shown in FIG. 1.

Moreover, a first dummy material portion 80a, a second dummy material portion 80b, and a detection material portion 80c are formed at a first position 22a, a second position 22b, and a third position 22c where the first compensation detection portion 13, the second compensation detection portion 15, and the reaction detection portion 17 are formed in the cavity 22, and a gas sensor 10 is obtained. In the formation process of the first dummy material portion 80a, the second dummy material portion 80b, and the detection material portion 80c, the first dummy material portion 80a, the second dummy material portion 80b, and the detection material portion 80c are formed by forming a coated body using a paste containing a dummy material or a gas detection material and subjecting the coated body to a heat treatment at a predetermined temperature.

The paste containing a dummy material or a gas detection material is obtained by mixing the above-mentioned raw material as the dummy material or the gas detection material, a solvent, a binder, and an additive.

### (1.9. Operation)

In the gas sensor 10, when an electric current flows through the heater film 50, the heater first portion 52a, the heater second portion 52b, and the heater third portion 52c generate heat, and the first compensation element 12, the second compensation element 14, and the detection element 16 on the membrane 18 are heated to a predetermined temperature.

As shown in FIG. 1, in the detection material portion 80c in contact with the reaction detection portion 17 in the detection element 16, when a gas to be detected is contained in the space where the gas sensor 10 is disposed, the gas to be detected combines with oxygen and burns on the surface of the detection material portion 80c due to the catalytic action of the gas detection material. As shown in FIG. 3B, the thermistor-film third portion 60c of the reaction detection portion 17 is thermally coupled to the detection material portion 80c. Thus, the detection-electrode third portion 70c of the reaction detection portion 17 detects a temperature change due to combustion of gas generated in the detection material portion 80c based on a resistance change of the thermistor-film third portion 60c.

In the first compensation element 12 and the second compensation element 14, the detection-electrode first portion 70a and the detection-electrode second portion 70b of the first and second compensation detection portions 13 and 15 detect resistance changes of the thermistor-film first portion 60a in contact with the first dummy material portion 80a and the thermistor-film second portion 60b in contact with the second dummy material portion 80b. Since the dummy materials contained in the first dummy material portion 80a and the second dummy material portion 80b do not react with the predetermined gas, the detection values of the first compensation element 12 and the second compensation element 14 reflect environmental changes other than changes in the concentration of the predetermined gas to be detected.

As is clear from FIG. 11A, since the first dummy material portion 80a and the second dummy material portion 80b have different formation areas, the gas sensor 10 can calculate a function (calibration curve) expressing a relation between the formation areas of the dummy material portions and the detection values from the comparison between the detection value of the first compensation element 12 and the detection value of the second compensation element 14. Due to the function expressing a relation between the formation areas of the dummy material portions and the detection values, the gas sensor 10 can calculate a detection value of a virtual compensation element including a dummy material portion having any coating area.

That is, the gas sensor 10 calculates a detection value of a virtual third compensation element formed in the same third formation area S3 as the reaction detection portion 17 and containing a dummy material based on a detection value of the first compensation element 12, the first formation area S1, a detection value of the second compensation element 14, and the second formation area S2. Next, a difference between the detection value of the detection element 16 and the detection value of the third compensation element is calculated. In this case, since the formation area of the detection element 16 and the formation area of the third compensation element correspond with each other, the calculated difference in detection value does not include an error due to the difference in formation area, and the difference in the calculated detection values accurately reflects the change in the detection value due to the combustion of gas generated in the detection material portion 80c. In the gas sensor 10, the concentration of a predetermined gas is calculated based on the values calculated in such a manner, and it is thereby possible to reduce correction errors due to manufacturing variations in the formation areas of the detection material portion 80c or the first and second dummy material portions 80a and 80b.

### 2. Second Embodiment

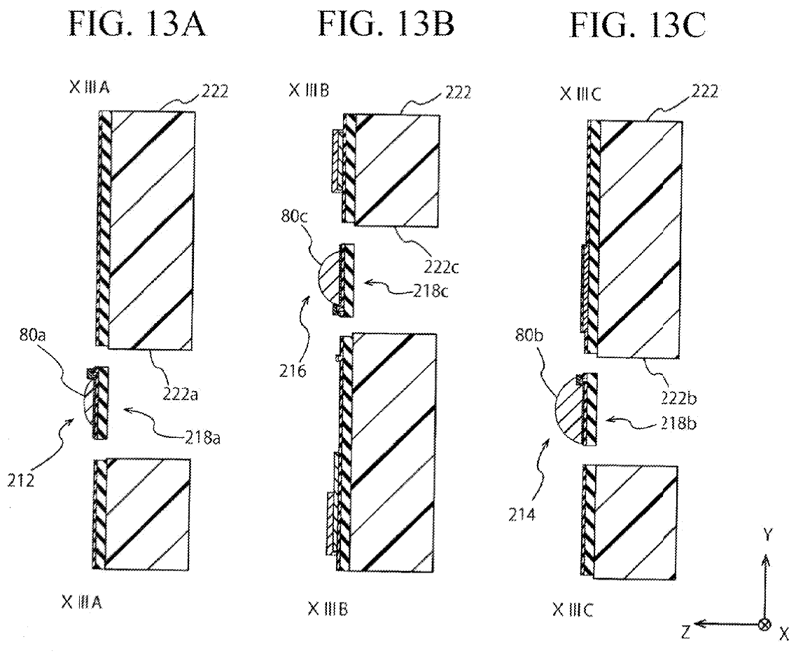

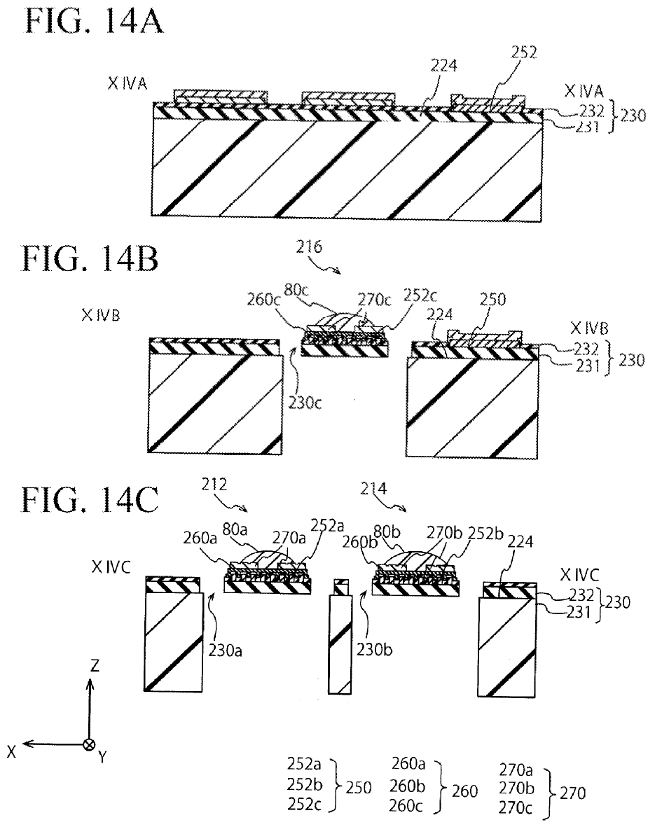

FIG. 12 is a plan view of a gas sensor 210 according to Second Embodiment, FIG. 13A to FIG. 13C are cross-sectional views of the gas sensor 210 in the YZ plane, and FIG. 14A to FIG. 14C are cross-sectional views of the gas sensor 210 in the XY plane. The gas sensor 210 is different from the gas sensor 10 shown in FIG. 1 in that a first compensation element 212, a second compensation element 214, and a detection element 216 are respectively arranged in a first cavity 222a, a second cavity 222b, and a third cavity 222c formed independently. Except for the shapes of the cavities and membrane, however, the basic structure of each portion of the gas sensor 210, such as the first compensation element 212, the second compensation element 214, and the detection element 216, is similar to that of the gas sensor 10. As for the gas sensor 210, the differences from the gas sensor 10 are mainly explained, and the common matters with the gas sensor 10 are not explained.

Similarly to the gas sensor 10, the gas sensor 210 includes at least three detection portions: a first compensation element 212, a second compensation element 214, and a detection element 216. As shown in FIG. 12, the first compensation element 212, the second compensation element 214, and the detection element 216 are arranged so that their respective center positions form apexes of one triangle in plan view. In the gas sensor 10 shown in FIG. 1, however, all elements are arranged in the integrated membrane 18, but in the gas sensor 210 shown in FIG. 12, the first compensation element 212, the second compensation element 214, and the detection element 216 are arranged on a first membrane 218a, a second membrane 218b, and a third membrane 218c, respectively, independent from each other.

As shown in FIG. 12 to FIGS. 14A-14C, the base member 220 is provided with three cavities: a first cavity 222a, a second cavity 222b, and a third cavity 222c. The first cavity 222a, the second cavity 222b, and the third cavity 222c are substantially rectangular in plan view and separated from each other by a cavity peripheral portion 224.

As shown in FIGS. 13A-13C and FIGS. 14A-14C, similarly to the first insulating film 31 and the second insulating film 32 shown in FIG. 1, a first insulating film 231 and a second insulating film 232 of the gas sensor 210 are formed on the upper side of the first to third cavities 222a to 222c and on the upper side of the cavity peripheral portion 224 constituting the upper surface of the base member 220. Also in the gas sensor 210, similarly to the gas sensor 10, the planar shapes of the first insulating film 231 and the second insulating film 232 substantially correspond with each other except for the portions where the heater terminals 95a and 95b are formed.

As shown in FIG. 12 and FIGS. 13A-13C, an insulating film 30 consisting of the first insulating film 231 and the second insulating film 232 includes a first membrane 218a, a second membrane 218b, and a third membrane 218c held on the upper side of the first cavity 222a, the second cavity 222b, and the third cavity 222c, respectively. Peripheral hole portions 234 and beam portions 233 are alternately arranged around the first to third membranes 218a to 218c so as to surround each of the first to third membranes 218a to 218c. The peripheral hole portions 234 are arranged corresponding to the sides of the first to third cavities 222a to 222c and the first to third membranes 218a to 218c, and the beam portions 233 are arranged corresponding to the corners of the first to third cavities 222a to 222c and the first to third membranes 218a to 218c.

The first to third membranes 218a to 218c have rectangular planar shapes that are slightly smaller than those of the first to third cavities 222a to 222c. The first to third membranes 218a to 218c are connected to other portions of the insulating film 30 on the cavity peripheral portion 224 via the beam portions 233 connected to the corners and are held above the first to third cavities 222a to 222c.

As shown in FIG. 14B and FIG. 14C, similarly to the heater film 50 of the gas sensor 10, a heater film 250 of the gas sensor 210 is formed between the first insulating film 231 and the second insulating film 232. As shown in FIG. 12, FIG. 13B, and FIG. 13C, the heater film 250 has a meander pattern and includes a heater first portion 252a, a heater second portion 252b, and a heater third portion 252c constituting a heater section. The heater first portion 252a is formed on the first membrane 218a, the heater second portion 252b is formed on the second membrane 218b, and the heater third portion 252c is formed on the third membrane 218c. As shown in FIG. 12, the heater first portion 252a, the heater second portion 252b, and the heater third portion 252c are wired to the cavity peripheral portion 224 via a heater-film wiring portion 253 as another portion of the heater film 250.

Similarly to the thermistor film 60 and the detection electrode film 70 of the gas sensor 10, a thermistor film 260 and a detection electrode film 270 of the gas sensor 210 are formed on the second insulating film 32. The thermistor film 260 and the detection electrode film 270 have three sections separated from each other, and each section constitutes a first compensation detection portion 213, a second compensation detection portion 215, and a reaction detection portion 217 shown in FIG. 12.

The thermistor film 260 includes: a thermistor-film first portion 260a located above the first cavity 222a and on the first membrane 218a; a thermistor-film second portion 260b located above the second cavity 222b and on the second membrane 218b; and a thermistor-film third portion 260c located above the third cavity 222c and on the third membrane 218c. The detection electrode film 270 includes: a detection-electrode first portion 270a located above the first cavity 222a and on the first membrane 218a; a detection-electrode second portion 270b located above the second cavity 222b and on the second membrane 218b; and a detection-electrode third portion 270c located above the third cavity 222c and on the third membrane 218c.

The detection-electrode first portion 270a, the detection-electrode second portion 270b, and the detection-electrode third portion 270c are wired to the cavity peripheral portion 224 via a detection-electrode-film wiring portion as another portion of the detection electrode film 270. The detection-electrode first portion 270a, the detection-electrode second portion 270b, and the detection-electrode third portion 270c detect resistance changes (mainly, due to temperature changes) of the thermistor-film first portion 260a, the thermistor-film second portion 260b, and the thermistor-film third portion 260c in contact with the detection-electrode first portion 270a, the detection-electrode second portion 270b, and the detection-electrode third portion 270c, respectively. Thus, the detection-electrode first portion 270a and the thermistor-film first portion 260a constitute the first compensation detection portion 213, the detection-electrode second portion 270b and the thermistor-film second portion 260b constitute the second compensation detection portion 215, and the detection-electrode third portion 270c and the thermistor-film third portion 260c constitute the reaction detection portion 217.

As shown in FIG. 12, FIG. 13B, and FIG. 14B, the detection material portion 80c is formed on the reaction detection portion 217 so as to overlap with the reaction detection portion 217 disposed above the third cavity 222c and on the third membrane 218c. The reaction detection portion 217 and the detection material portion 80c arranged on the third membrane 218c constitute the detection element 216 above the third cavity 222c.

Also, as shown in FIG. 12, FIG. 13A, and FIG. 14C, the first dummy material portion 80a is formed on the first compensation detection portion 213 so as to overlap with the first compensation detection portion 213 disposed above the first cavity 222a and on the first membrane 218a. The first compensation detection portion 213 and the first dummy material portion 80a arranged on the first membrane 218a constitute the first compensation element 212 above the first cavity 222a.

Also, as shown in FIG. 12, FIG. 13C, and FIG. 14C, the second dummy material portion 80b is formed on the second compensation detection portion 215 so as to overlap with the second compensation detection portion 215 disposed above the second cavity 222b and on the second membrane 218b. The second compensation detection portion 215 and the second dummy material portion 80b arranged on the second membrane 218b constitute the second compensation element 214 above the second cavity 222b.

In the gas sensor 210, the first dummy material portion 80a has a first formation area S1, the second dummy material portion 80b has a second formation area S2, and the detection material portion 80c has a third formation area S3. This is similar to the gas sensor 10.

The material and manufacturing method of the base member 220, the insulating film 230, the heater film 250, the detection electrode film 270, the thermistor film 260, the detection material portion 80c, the first dummy material portion 80a, the second dummy material portion 80b, etc. constituting the gas sensor 210 are similar to those of the base member 20, the insulating film 30, the heater film 50, the detection electrode film 70, the thermistor film 60, the detection material portion 80c, the first dummy material portion 80a, the second dummy material portion 80b, etc. constituting the gas sensor 10.

In the gas sensor 210 shown in FIG. 12 to FIGS. 14A-14C, the detection element 216, the first compensation element 212, and the second compensation element 214 are arranged on the membranes 218a to 218c and above the cavities 222a to 222c separated from each other. Compared to the gas sensor 10, such a gas sensor 210 is advantageous in that the first compensation element 212 and the second compensation element 214 are less affected by gas combustion in the detection element 216. Also, since the cavities are separated for each element, each membrane becomes small, and the gas sensor 210 thereby becomes less likely to be destroyed by stress or physical impact. On the other hand, measurement errors tend to easily occur due to variations in heat radiation among the cavities 222a to 222c.

In the gas sensor 210, however, similarly to the gas sensor 10, the measurement errors of each of the cavities 222a to 222c can be reduced as much as possible by equalizing the distances between the detection element 216, the first compensation element 212, and the second compensation element 214 and arranging the elements close together within one base member 220. Regarding the common matters, the gas sensor 210 demonstrates effects similar to those of the gas sensor 10.

### Third Embodiment

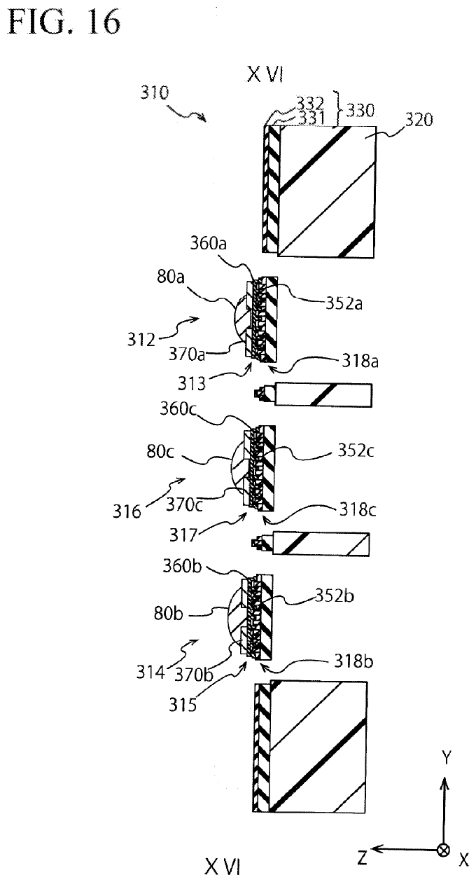

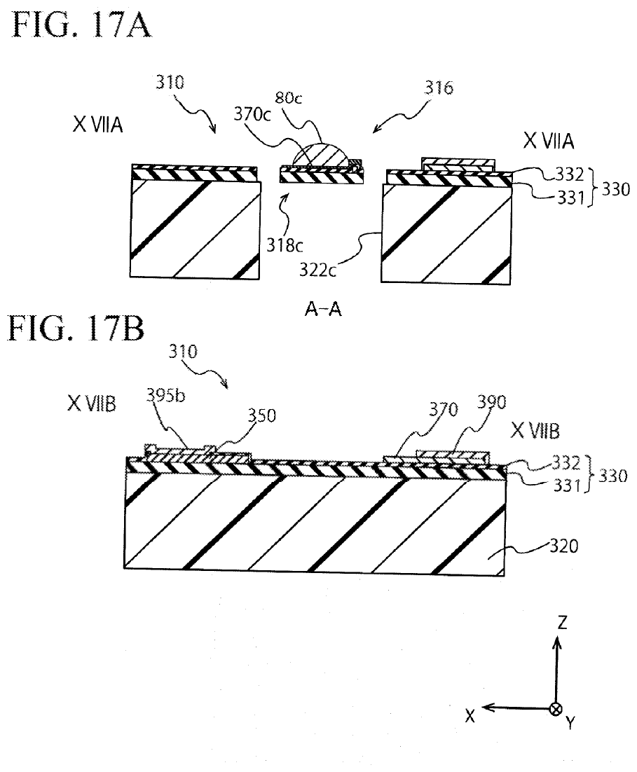

FIG. 15 is a plan view of a gas sensor 310 according to Third Embodiment, FIG. 16 is a cross-sectional view of the gas sensor 310 along the YZ plane, and FIG. 17 is a cross-sectional view of the gas sensor 310 along the XY plane. In the gas sensor 310, a first compensation element 312, a detection element 316, and a second compensation element 314 are arranged linearly. In this respect, the gas sensor 310 is different from the gas sensor 210, in which the first compensation element 212, the detection element 216, and the second compensation element 214 are arranged in a triangle. Except for the arrangement of elements, however, the gas sensor 310 is similar to the gas sensor 210. As for the gas sensor 310, the differences from the gas sensor 10 are mainly explained, and the common matters with the gas sensor 10 are not explained.

Similarly to the gas sensor 210, the gas sensor 310 includes at least three detection sections: a first compensation element 312, a second compensation element 314, and a detection element 316. As shown in FIG. 15, the first compensation element 312, the detection element 316, and the second compensation element 314 are arranged so that their respective center positions are arranged linearly in plan view. In the gas sensor 310 shown in FIG. 15, similarly to the gas sensor 210 shown in FIG. 12, the first compensation element 312, the second compensation element 314, and the detection element 316 are arranged on a first membrane 318a, a second membrane 318b, and a third membrane 318c, respectively, independent from each other.

As shown in FIG. 15 to FIGS. 17A and 17B, a base member 320 is provided with three cavities of a first cavity 322a, a second cavity 322b, and a third cavity 322c formed along the Y-axis direction. The first cavity 322a, the second cavity 322b, and the third cavity 322c are substantially rectangular in plan view and are separated from each other by a cavity peripheral portion 324.

Similarly to the first insulating film 231 and the second insulating film 232 shown in FIGS. 13A-13C and FIGS. 14A-14C, a first insulating film 33l and a second insulating film 332 of the gas sensor 310 are formed on the upper side of the first to third cavities 322a to 322c and on the upper side of the cavity peripheral portion 324 constituting the upper surface of the base member 320. Also in the gas sensor 310, similarly to the gas sensor 210, the planar shapes of the first insulating film 33l and the second insulating film 332 substantially correspond with each other except for the portions where the heater terminals 395a and 395b are formed.

As shown in FIG. 15 and FIG. 16, an insulating film 30 consisting of the first insulating film 33l and the second insulating film 332 includes a first membrane 318a, a second membrane 318b, and a third membrane 318c held on the upper side of the first cavity 322a, the second cavity 322b, and the third cavity 322c, respectively. Peripheral hole portions 334 and beam portions 333 are alternately arranged around the first to third membranes 318a to 318c so as to surround each of the first to third membranes 318a to 318c. The peripheral hole portions 334 are arranged corresponding to the sides of the first to third cavities 322a to 322c and the first to third membranes 318a to 318c, and the beam portions 333 are arranged corresponding to the corners of the first to third cavities 322a to 322c and the first to third membranes 318a to 318c.

The first to third membranes 318a to 318c have rectangular planar shapes that are slightly smaller than those of the first to third cavities 322a to 322c. The first to third membranes 318a to 318c are connected to other portions of the insulating film 30 on the cavity peripheral portion 324 via the beam portions 333 connected to the corners and are held above the first to third cavities 322a to 322c.

As shown in FIG. 16 and FIG. 17A, similarly to the heater film 250 of the gas sensor 210, a heater film 350 of the gas sensor 310 is formed between the first insulating film 33l and the second insulating film 332. As shown in FIG. 15, the heater film 350 has a meander pattern and includes a heater first portion 352a, a heater second portion 352b, and a heater third portion 352c constituting a heater section. The heater first portion 352a is formed on the first membrane 318a, the heater second portion 352b is formed on the second membrane 318b, and the heater third portion 352c is formed on the third membrane 318c. As shown in FIG. 15, the heater first portion 352a, the heater second portion 352b, and the heater third portion 352c are wired to the cavity peripheral portion 324 via a heater-film wiring portion 353 as another portion of the heater film 350.

Similarly to the thermistor film 260 and the detection electrode film 270 of the gas sensor 210, a thermistor film 360 and a detection electrode film 370 of the gas sensor 310 are formed on the second insulating film 332. The thermistor film 360 and the detection electrode film 370 have three sections separated from each other, and each section constitutes a first compensation detection portion 313, a second compensation detection portion 315, and a reaction detection portion 317 shown in FIG. 16.

The thermistor film 360 includes: a thermistor-film first portion 360a located above the first cavity 322a and on the first membrane 318a; a thermistor-film second portion 360b located above the second cavity 322b and on the second membrane 318b; and a thermistor-film third portion 360c located above the third cavity 322c and on the third membrane 318c. The detection electrode film 370 includes: a detection-electrode first portion 370a located above the first cavity 322a and on the first membrane 318a; a detection-electrode second portion 370b located above the second cavity 322b and on the second membrane 318b; and a detection-electrode third portion 370c located above the third cavity 322c and on the third membrane 318c.

The detection-electrode first portion 370a, the detection-electrode second portion 370b, and the detection-electrode third portion 370c are wired to the cavity peripheral portion 324 via a detection-electrode-film wiring portion as another portion of the detection electrode film 370. The detection-electrode first portion 370a, the detection-electrode second portion 370b, and the detection-electrode third portion 370c detect resistance changes (mainly, due to temperature changes) of the thermistor-film first portion 360a, the thermistor-film second portion 360b, and the thermistor-film third portion 360c in contact with the detection-electrode first portion 370a, the detection-electrode second portion 370b, and the detection-electrode third portion 370c, respectively. Thus, the detection-electrode first portion 370a and the thermistor-film first portion 360a constitute the first compensation detection portion 313, the detection-electrode second portion 370b and the thermistor-film second portion 360b constitute the second compensation detection portion 315, and the detection-electrode third portion 370c and the thermistor-film third portion 360c constitute the reaction detection portion 317.

As shown in FIG. 15, FIG. 16, and FIG. 17A, the detection material portion 80c is formed on the reaction detection portion 317 so as to overlap with the reaction detection portion 317 disposed above the third cavity 322c and on the third membrane 318c. The reaction detection portion 317 and the detection material portion 80c arranged on the third membrane 318c constitute the detection element 316 above the third cavity 322c.

The first dummy material portion 80a is formed on the first compensation detection portion 313 so as to overlap with the first compensation detection portion 313 disposed above the first cavity 322a and on the first membrane 318a. The first compensation detection portion 313 and the first dummy material portion 80a arranged on the first membrane 318a constitute the first compensation element 312 above the first cavity 322a.

The second dummy material portion 80b is formed on the second compensation detection portion 315 so as to overlap with the second compensation detection portion 315 disposed above the second cavity 322b and on the second membrane 318b. The second compensation detection portion 315 and the second dummy material portion 80b arranged on the second membrane 318b constitute the second compensation element 314 above the second cavity 322b.

In the gas sensor 310, the first dummy material portion 80a has a first formation area S1, the second dummy material portion 80b has a second formation area S2; and the detection material portion 80c has a third formation area S3. In this respect, the gas sensor 310 is similar to the gas sensor 210. As shown in FIG. 15 and FIG. 17B, the heater terminals 395a and 395b and electrode terminals 397a to 397e of a terminal electrode film 390 are formed on both sides in the Y-axis direction of the first compensation element 312, the detection element 316, and the second compensation element 314 arranged linearly.

The material and manufacturing method of the base member 320, the insulating film 330, the heater film 350, the detection electrode film 370, the thermistor film 360, the detection material portion 80c, the terminal electrode film 390, the first dummy material portion 80a, the second dummy material portion 80b, etc. constituting the gas sensor 310 are similar to those of the base member 20, the insulating film 30, the heater film 50, the detection electrode film 70, the thermistor film 60, the terminal electrode film 90, the detection material portion 80c, the first dummy material portion 80a, the second dummy material portion 80b, etc. constituting the gas sensor 10.

In the gas sensor 310 shown in FIG. 15 to FIGS. 17A and 17B, the first compensation element 312, the detection element 316, and the second compensation element 314 are arranged on the membranes 318a to 318c and above the cavities 322a to 322c separated and linearly arranged. In such a gas sensor 310, temperature differences tend to easily occur between the third cavity 322c disposed in a central part of one continuous base member 320 and the first and second cavities 322a and 322b close to the ends of the base member 320.

In the gas sensor 310, however, similarly to the gas sensor 210, the environment between the first compensation element 312 and the second compensation element 314 can be uniform by equalizing the distance between the detection element 316 and the first compensation element 312 and the distance between the detection element 316 and the second compensation element 314. Regarding the common matters, the gas sensor 310 demonstrates effects similar to those of the gas sensor 210.

Hereinafter, the gas sensor according to the present disclosure is described in more detail with examples, but the gas sensor according to the present disclosure is not limited to only these examples at all.

### 4. First Example

In First Example, a gas sensor 10 shown in FIG. 1 was manufactured as one MEMS chip under the following conditions, and obtained were detection values from a detection element 16, a first compensation element 12, and a second compensation element 14 when gas concentration was varied.

### <Conditions for Manufacturing Gas Sensor>

Base Member 20: Si
First Insulating Film 31: SiN/SiO₂
Second Insulating Film 32: SiN
Heater Film 50: Pt
Detection Electrode Film 70 and Terminal Electrode Film 90: Au
Thermistor film: NiMnCoFeOₓ
First Dummy Material Portion 80a: Al₂O₃ (dummy material)
First Formation Area S1: φ140 μm circular
Second Dummy Material Portion 80b: Al₂O₃ (dummy material)
Second Formation Area S2: φ158 μm circular
Detection Material Portion 80c: Pt-supported Al₂O₃ (gas detection material)
Third Formation Area S3: φ151 μm circular

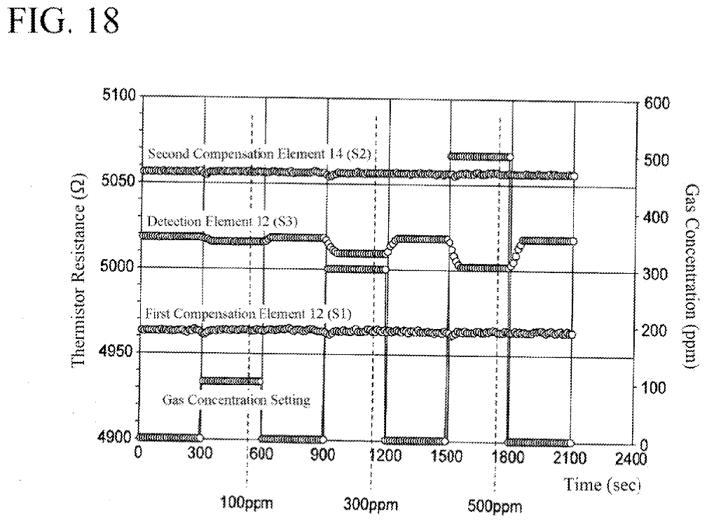

FIG. 18 is a graph showing the detection values of the detection element 16, the first compensation element 12, and the second compensation element 14 of the gas sensor 10 according to First Example and the time changes of gas concentration settings in the space where the gas sensor 10 is installed. In FIG. 18, the plots starting from the lowest part of the graph in the initial state (time 0 sec) represent gas concentration settings. The gas concentration was set at 100 ppm for 300 to 600 seconds, at 300 ppm for 900 to 1200 seconds, at 500 ppm for 1500 to 1800 seconds, and at 0 ppm for other times. Gases to be detected were CO, H₂, CH₄, and C₂H₅OH. The environmental temperature and humidity during the measurement were kept constant (25° C., 30%).

In FIG. 18, the plots starting from the top of the graph in the initial state (time 0 sec) represent detection values of the second compensation element 14, the plots starting from the second from the top of the graph represent detection values of the detection element 16, and the plots starting from the third from the top of the graph represent detection values of the first compensation element 12. As shown in FIG. 18, a change in the detection value of the detection element 16 corresponding to the gas concentration setting was observed, but no change in the detection values of the first compensation element 12 and the second compensation element 14 corresponding to the gas concentration setting was observed.

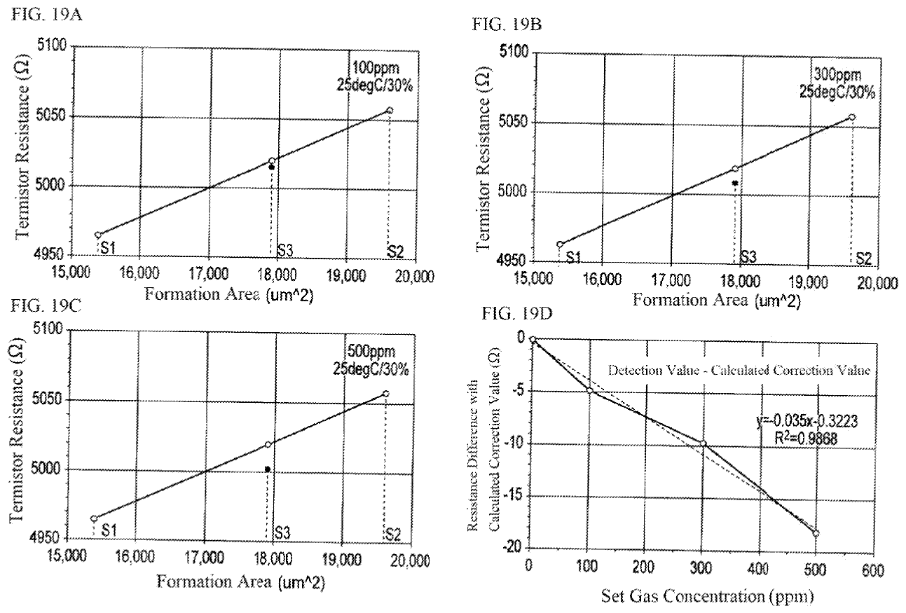

FIG. 19A to 19C are graphs plotting the relation between: the detection values of the elements 12, 14, and 16 at the gas concentrations of 100 ppm (FIG. 19A), 300 ppm (FIG. 19B), and 500 ppm (FIG. 19C) obtained from the detection results shown in FIG. 18; and the formation areas (first to third formation areas S1 to S3) of the first and second dummy material portions 80a and 80b and the detection material portion 80c. In FIG. 19A to FIG. 19C, the white circle plotted at the position where the formation area on the horizontal axis is S1 is the detection value of the first compensation element 12, and the white circle plotted at the position where the formation area on the horizontal axis is S2 is the detection value of the second compensation element 14.

Also, the black circle plotted at the position where the formation area on the horizontal axis is S3 is the detection value of the detection element 16. As shown in FIG. 19A to FIG. 19C, the gas sensor 10 calculates a detection value of a virtual third compensation element formed in the same third formation area S3 as the reaction detection portion 80c and containing a dummy material based on the detection value of the first compensation element 12, the first formation area S1, the detection value of the second compensation element 14, and the second formation area S2. In FIG. 19A to FIG. 19C, the white circle plotted at the position where the formation area on the horizontal axis is S3 is the detection value (calculation value) of the calculated virtual third compensation element.

FIG. 19D is a graph in which the difference (resistance difference (Ω)) between the detection value of the detection element 16 (black circle at the position of S3 in the horizontal axis) and the detection value (calculation value) of the third compensation element (white circle at the position of S3 in the horizontal axis) shown in FIG. 19A to FIG. 19C is plotted against gas concentration (horizontal axis). As shown in FIG. 19D, it was confirmed that the difference between the detection value of the detection element 16 and the detection value of the third compensation element regresses to a proportional function of gas concentration, and that the residual difference between the sample value and the function is small.

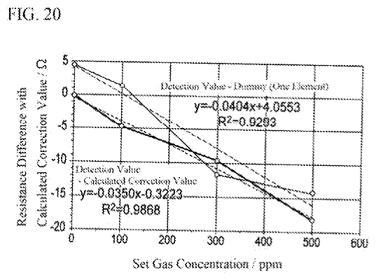

FIG. 20 is a graph showing the results of detection similar to that of First Example shown in FIG. 18 and FIGS. 19A-19D using a gas sensor according to Reference Example together with the results of First Example shown in FIG. 19D. The gas sensor according to Reference Example was made of two elements: one compensation element and one detection element (the target value of the formation area was the same). As shown in FIG. 20, it was confirmed that, compared to the gas sensor according to Reference Example, the gas sensor according to First Example has a smaller residual difference between the sample value and the function and can detect the gas concentration with high accuracy.

### Second Example

In Second Example, a gas sensor 10 similar to that in First Example was employed, and detection values of a detection element 16, a first compensation element 12, and a second compensation element 14 were similarly obtained by changing the humidity and gas concentration. The gas concentration was varied between 0 ppm and 100 ppm, and the humidity was set to three conditions: 30%, 50%, and 70%. The environmental temperature was kept constant (25° C.).

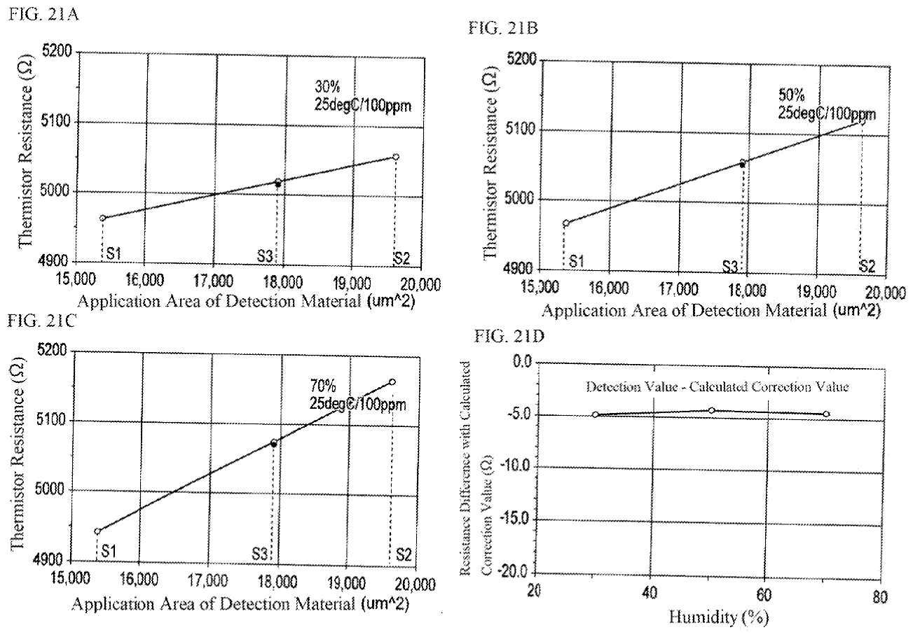

FIG. 21A to FIG. 21C are graphs in which the relation between the detection values of the elements 12, 14, and 16 at humidity levels of 30% (FIG. 21A), 50% (FIG. 21B), and 70% (FIG. 21C) obtained in Second Example and the formation areas (first to third formation areas S1 to S3) of the first and second dummy material portions 80a and 80b and the detection material portion 80c are plotted as in FIG. 19A to FIG. 19C.

Also in Second Example, similarly to First Example, a detection value of a virtual third compensation element formed in the same third formation area S3 as the reaction detection portion 80c and containing a dummy material was calculated based on the detection value of the first compensation element 12, the first formation area S1, the detection value of the second compensation element 14, and the second formation area S2. In FIG. 21A to FIG. 21C, the white circle plotted at the position where the formation area on the horizontal axis is S3 is the detection value (calculation value) of the calculated virtual third compensation element.

FIG. 21D is a graph in which the difference (resistance difference (Ω)) between the detection value of the detection element 16 (black circle at the position of S3 in the horizontal axis) and the detection value (calculation value) of the third compensation element (white circle at the position of S3 in the horizontal axis) shown in FIG. 21A to FIG. 21C is plotted against humidity (horizontal axis). As shown in FIG. 21D, the difference between the detection value of the detection element 16 and the detection value of the third compensation element was substantially constant regardless of the humidity. It was confirmed that the humidity correction portion 11 of the gas sensor 10 shown in FIG. 1 can correct humidity with high accuracy using the detection values of each element.

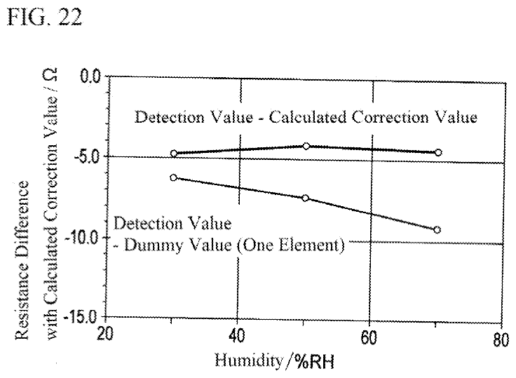

FIG. 22 is a graph showing the results of detection similar to that of Second Example shown in FIG. 21 using the gas sensor according to Reference Example together with the results of Second Example shown in FIG. 21D. Similarly to Reference Example shown in FIG. 20, the gas sensor according to Reference Example was made of two elements: one compensation element and one detection element (the target value of the formation area was the same). As shown in FIG. 22, it was confirmed that the gas sensor according to Second Example had a variation in detection values due to humidity smaller than that in Reference Example and can detect the gas concentration with high accuracy even in environments where humidity changes.

### Description of the Reference Numerical

10, 210, 310 . . . gas sensor
11 . . . humidity correction portion
12, 212, 312 . . . first compensation element
13, 213, 313 . . . first compensation detection portion
14, 214, 314 . . . second compensation element
15, 215, 315 . . . second compensation detection portion
16, 216, 316 . . . detection element
17, 217, 317 . . . reaction detection portion
18 . . . membrane
218a, 318a . . . first membrane
218b, 318b . . . second membrane
218c, 318c . . . third membrane
20, 220, 320 . . . base member
22 . . . cavity
222a, 322a . . . first cavity
222b, 322b . . . second cavity
222c, 322c . . . third cavity
22a . . . first position
22b . . . second position
22c . . . third position
24, 224, 324 . . . cavity peripheral portion
30, 230, 330 . . . insulating film
30a . . . insulating-film first portion
30b . . . insulating-film second portion
30c . . . insulating-film third portion
31, 231, 33l . . . first insulating film
32, 232, 332 . . . second insulating film
33a-33i, 233, 333 . . . beam portion
34a-34i, 234, 334 . . . peripheral hole portion
35 . . . central hole portion
36 . . . insulating-film peripheral portion
50, 250, 350 . . . heater film
52a, 252a, 352a . . . heater first portion
52b, 252b, 352b . . . heater second portion
52c, 252c, 352c . . . heater third portion
53, 253, 353 . . . heater-film wiring portion
60, 260, 360 . . . thermistor film
60a, 260a, 360a . . . thermistor-film first portion
60b, 260b, 360b . . . thermistor-film second portion
60c, 260c, 360c . . . thermistor-film third portion
65 . . . thermistor central hole portion
70, 270, 370 . . . detection electrode film
70a, 270a, 370a . . . detection-electrode first portion
70b, 270b, 370b . . . detection-electrode second portion
70c, 270c, 370c . . . detection-electrode third portion
80a . . . first dummy material portion
S1 . . . first formation area
80b . . . second dummy material portion
S2 . . . second formation area
80c . . . detection material portion
S3 . . . third formation area
90, 390 . . . terminal electrode film
95a, 95b, 395a, 395b . . . heater terminal
97a-97e, 397a-397e . . . electrode terminal

What is claimed is:

1. A gas sensor comprising:
a base member provided with a cavity;
a first insulating film formed above the cavity and on a cavity peripheral portion,
a second insulating film formed so as to overlap with the first insulating film;
a heater section formed between the first insulating film and the second insulating film;
a first compensation element including:
a first dummy material portion formed in a first formation area on the heater section and the second insulating film at a first position above the cavity, the first dummy material portion being containing a dummy material that does not react with a predetermined gas; and
a first compensation detection portion detecting a physical quantity of the first dummy material portion;
a second compensation element including:
a second dummy material portion formed in a second formation area, different from the first formation area, on the heater section and the second insulating film at a second position above the cavity, the second dummy material portion being containing the dummy material; and
a second compensation detection portion detecting a physical quantity of the second dummy material portion; and
a detection element including:
a detection material portion formed on the heater section and the second insulating film at a third position above the cavity, the detection material portion being containing a gas detection material that reacts with the predetermined gas; and
a reaction detection portion detecting a physical quantity of the detection material portion.

2. The gas sensor according to claim 1, comprising a humidity correction section performing humidity correction on a detection value of the reaction detection portion using detection values of the first compensation detection portion and the second compensation detection portion.

3. The gas sensor according to claim 1, wherein
the reaction detection portion is formed in a third formation area, and
the third formation area is larger than either one of the first formation area and the second formation area and smaller than the other of the first formation area and the second formation area.

4. The gas sensor according to claim 1, wherein a first distance between the detection element and the first compensation element and a second distance between the detection element and the second compensation element are substantially equal to each other.

5. The gas sensor according to claim 1, wherein a line connecting a center position of the detection element, a center position of the first compensation element, and a center position of the second compensation element forms a substantially equilateral triangle.

6. The gas sensor according to claim 1, wherein
the cavity of the base member is an integrated cavity in which the detection element, the first compensation element, and the second compensation element are arranged above,
an insulating-film first portion is a portion located at the first position of the first insulating film and/or the second insulating film,
an insulating-film second portion is a portion located at the second position of the first insulating film and/or the second insulating film,
an insulating-film third portion is a portion located at the third position of the first insulating film and/or the second insulating film, and
the insulating-film first portion, the insulating-film second portion, and the insulating-film third portion form an integrated membrane connected to each other without a portion for being fixed to the cavity peripheral portion.

7. A method of detecting gas with the gas sensor according to claim 1, comprising the steps of:
calculating a detection value of a virtual third compensation element assumed to be formed in the same third formation area as the reaction detection portion and assumed to contain the dummy material, based on a detection value of the first compensation element, the first formation area, a detection value of the second compensation element, and the second formation area; and
calculating a concentration of the predetermined gas based on a difference between the detection value of the detection element and the detection value of the third compensation element.
